(19) United States
(12) Patent Application Publication
(10) Pub. No.: US 2024/0315513 A1
(43) Pub. Date: Sep. 26, 2024

(54) Hand-Held Steam Cleaning Apparatus

(71) Applicant: Positec Power Tools (Suzhou) Co., Ltd, Suzhou (CN)

(72) Inventors: Rui Meng, Suzhou (CN); Kaixiang Zhang, Suzhou (CN); Xiangliang Zhang, Suzhou (CN)

(21) Appl. No.: 18/680,790

(22) Filed: May 31, 2024

Related U.S. Application Data
(63) Continuation of application No. PCT/CN2023/072221, filed on Jan. 14, 2023.

(30) Foreign Application Priority Data
Sep. 23, 2022 (CN) 202211164521.1

(51) Int. Cl. A47L 11/40; A47L 11/34

(52) U.S. Cl. CPC A47L 11/4005; A47L 11/34; A47L 11/4036; A47L 11/4083; A47L 11/4086; A47L 11/4088

(57) ABSTRACT

A hand-held steam cleaning apparatus including: a housing, provided with a handle; a steam generating unit, including a heating body and configured to heat water and vaporize the water into steam; a steam nozzle, configured to output the steam; and a water supply device, including a water tank and pump configured to pump the water in the water tank into the steam generating unit. The cleaning apparatus is powered by a battery pack. The weight of the cleaning apparatus is not greater than 2 kg when the housing is fitted with the battery pack and the water tank is fully loaded; the capacity of the battery pack is in the range of 36-144 Wh. The steam flow capacity is in the range of 3-12 g/min; and the continuous work time is not less than 2 min.

### CROSS-REFERENCE TO RELATED APPLICATIONS

This application is a continuation of PCT Application No. PCT/CN2023/072221, filed on Jan. 14, 2023, which claims benefit of and priority to Chinese Patent Application No. 202211164521.1, filed on Sep. 23, 2022, all of which are hereby incorporated by reference in their entireties for all purposes as if fully set forth herein.

### TECHNICAL FIELD

This application relates to the technical field of cleaning apparatuses, and, more particularly, to hand-held steam cleaning devices or apparatuses.

### BACKGROUND

A wired mode of an alternating current (AC) power source is usually used by a steam cleaning apparatus in the conventional techniques, so people don't have to worry about the problem of endurance. However, there is an occasion requirement for using the AC power source, namely, requiring a connection to the mains supply or other power supply units nearby. The AC power source serves as a power supply for a heater and a water pump, but it is inconvenient for use outdoors or in places where the mains supply is unavailable, and operation with a power line is also inconvenient. Because there is no endurance limitation problem of the AC power source, the power of the heater of such a steam cleaning apparatus is generally high, a larger amount of water is heated at once using the boiler type heater, the time for the user to wait for production of steam is long, inevitably leading to a large-volume and heavy cleaning apparatus which is laborious for the user to hold for operation and is not portable.

With the development of the economy and the progress of the society, people are more respectful of a clean and healthy living environment. The household cleaning apparatus is gradually applied in people's life, and the most common cleaning tools include floor washers, vacuum cleaners, floor-sweeping robots, etc. These cleaning tools are suitable for the needs of large-area cleaning, but there are some scenarios in the family that often require fixed-point cleaning, such as the cleaning of ink stains on sofa, stains on cloth, rust stains on washing tables or cooking utensils, recent oil stains in the cooking range, pet stains, etc. The scrubbing and cleaning effect of ordinary wet scrubbing tools is poor. Using steam instead of detergent for daily cleaning is more environmentally friendly and the steam is free of chemical components and more healthy for the skin, causing no injure to the skin. The high-temperature steam kills bacteria, mites and other harmful organisms, helping to create a clean living space.

This type of steam cleaning apparatus is becoming more and more popular with people who promote the lifestyle of health and environmental protection, and is also a product that is in line with the trend of the times. A cordless, hand-held and lightweight cleaning apparatus convenient to operate can be truly portable and is suitable for work situations where fixed-point cleaning is required. For the rechargeable battery pack as a working power source, there are new demands for the time of endurance of the single battery pack, the cleaning capacity of the steam and the maneuverability of the hand-held tool in this category of cordless steam cleaning tools.

### SUMMARY

The present disclosure provides a hand-held steam cleaning apparatus which includes: a housing, provided with a handle for holding; a steam generating unit, comprising a heating body and configured to heat and vaporize water into steam; a steam nozzle, configured to output the steam; a water supply device, comprising a water tank and a water pump configured to pump water in the water tank into the steam generating unit, and a control device, configured to control the operation of the water pump and heating body. Wherein the cleaning apparatus is powered by a battery pack, wherein a weight of the cleaning apparatus is not greater than 2 kg when the housing is fitted with the battery pack and the water tank is fully loaded, wherein a capacity of the battery pack is in a range of 36-144 Wh, wherein the steam flow capacity is in a range of 3-12 g/min, wherein the steam generating unit is configured to produce a steam flow capacity M, when performing cleaning work, wherein the cleaning apparatus has a continuous work time T, defined from a start of steam production to an end of steam production, and wherein the continuous work time is not less than 2 min.

In some examples, a product MT of the steam flow capacity and the continuous work time is defined as a cleanable power of the cleaning apparatus; the cleaning power MT is between 25.2 g˜166 g.

In some examples, a weight when the housing is fitted with the battery pack and the water tank is fully loaded is a whole machine weight G, and a ratio MT/G of the product MT of the steam flow capacity and the continuous work time to the whole machine weight G of the cleaning apparatus is the cleanable power per unit weight, a value of the cleanable power per unit weight MT/G satisfies 0.0216≤MT/G≤0.1060.

In some examples, the power of the steam generating unit is in the range of 120-600 W.

In some examples, the thermal efficiency of the steam generating unit is greater than 70%.

In some examples, the housing comprises a main body, an obtuse angle is set between an axis of the main body and an axis of the handle, an end of the handle away from the main body is provided with a mounting base, the battery pack is detachably connected to the mounting base, the bottom of the battery pack is provided with a support surface that supports the cleaning device upright on a reference plane.

In some examples, the steam generating unit is accommodated in the main body. For example, the steam nozzle, the steam generating unit, and the water tank are arranged in sequence along the axis of the main body.

In some examples, an auxiliary brush head is detachably coupled to the steam nozzle, a brush surface of the auxiliary brush head is approximately parallel to the axis of the handle.

In some examples, the control device comprises a control trigger set on the handle and a circuit board, the control trigger is electrically connected to the circuit board and the battery pack, the control trigger is configured to start the operation of the water pump and the heating body to produce instant steam.

The present disclosure provides another hand-held steam cleaning apparatus which includes: a housing, provided with a handle for holding; a steam generating unit, disposed in the housing, including a heating body, and configured to heat and vaporize water into steam; a steam nozzle, communicating with the steam generating unit and configured to output the steam; and a water supply device, configured to deliver liquid to the steam generating unit. The water supply device includes a water tank and a water pump configured to pump water in the water tank into the steam generating unit. The hand-held steam cleaning apparatus is powered by a battery pack. The steam generating unit is configured to produce a steam flow capacity, M, when performing cleaning work, the cleaning apparatus has a continuous work time, T, defined from a start of steam production to an end of steam production. A product MT of the steam flow capacity and the continuous work time is defined as a cleanable power of the cleaning apparatus, a weight when the housing is fitted with the battery pack and the water tank is fully loaded is a whole machine weight G, and a ratio MT/G of the product MT of the steam flow capacity and the continuous work time to the whole machine weight G of the hand-held steam cleaning apparatus is the cleanable power per unit weight. A value of the cleanable power per unit weight MT/G satisfies 0.0216≤MT/G≤0.1060.

In some examples, the value of the cleanable power per unit weight MT/G satisfies 0.0309≤MT/G≤0.1060.

In some examples, the steam flow capacity is greater than or equal to 3 g/min. For example, the steam flow capacity is greater than or equal to 4 g/min.

In some examples, the steam flow capacity is less than or equal to 12 g/min. For example, the steam flow capacity is less than or equal to 8 g/min.

In some examples, the capacity of the battery pack is greater than or equal to 36 Wh. For example, the capacity of the battery pack is less than or equal to 144 Wh.

In some examples, the whole machine weight G is not greater than 2 kg.

In some examples, the power of the steam generating unit is in the range of 120-600 W. For example, the power of the steam generating unit is in the range of 180-400 W.

In some examples, a resistance range of the heating body is 0.65-6.91 ohms.

In some examples, the thermal efficiency of the steam generating unit is greater than 70%. For example, the thermal efficiency of the steam generating unit is 85% to 95%.

The present disclosure provides another hand-held steam cleaning apparatus for which, when performing cleaning work at a steam flow capacity M, the continuous work time from the start of steam production to the stop of steam production is T. The hand-held steam cleaning apparatus includes: a housing, provided with a handle for holding; a steam generating unit, including a heating body and configured to heat water and vaporize the water into steam; a steam nozzle, configured to output the steam; and a water supply device, including a water tank and a water pump configured to pump the water in the water tank into the steam generating unit, and a control device, configured to control the water pump and heating body to produce instant steam. The hand-held steam cleaning apparatus is powered by a battery pack. The weight of the hand-held steam cleaning apparatus is not greater than 2 kg when the housing is fitted with the battery pack and the water tank is fully loaded. a product MT of the steam flow capacity and the continuous work time is defined as a cleanable power of the hand-held steam cleaning apparatus, the cleaning power MT of the cleanable power of the hand-held steam cleaning apparatus is between 25.2 g˜166 g.

In some examples, a weight when the housing is fitted with the battery pack and the water tank is fully loaded is a whole machine weight G, and a ratio MT/G of the product MT of the steam flow capacity and the continuous work time to the whole machine weight G of the hand-held steam cleaning apparatus is the cleanable power per unit weight; a value of the cleanable power per unit weight MT/G satisfies 0.0216≤MT/G≤0.1060.

Some illustrative advantages of the present disclosure include: the hand-held steam cleaning apparatus provided by this application is portable and light in operation because no power line is provided, which can meet the use needs of more cleaning scenarios, and is more in line with user's expectations for a DC hand-held steam cleaning apparatus in terms of power and performance, making cleaning in a family and creating a healthy and clean living space more convenient.

### BRIEF DESCRIPTION OF THE DRAWINGS

FIG. 1 is a schematic view of a hand-held steam cleaning apparatus provided by an embodiment of this application placed on a horizontal plane in the main view direction;

FIG. 2 is a three-dimensional schematic view of the hand-held steam cleaning apparatus in FIG. 1;

FIG. 3 is a three-dimensional schematic view of a hand-held steam cleaning apparatus provided by this application when a battery pack and part of a shell are removed;

FIG. 4 is a cross-sectional schematic view of the hand-held steam cleaning apparatus in FIG. 3 when the battery pack and part of the shell are removed;

FIG. 5a is a three-dimensional schematic view of an auxiliary cleaning member for a light work condition provided by an embodiment of this application;

FIG. 5b is a cross-sectional schematic view of the auxiliary cleaning member in FIG. 5a;

FIG. 5c shows the auxiliary cleaning member in FIG. 5a and a cloth sleeve in detachable matched connection with the auxiliary cleaning member;

FIG. 6a is a three-dimensional schematic view of an auxiliary cleaning member for a medium work condition provided by an embodiment of this application;

FIG. 6b is a cross-sectional schematic view of the auxiliary cleaning member in FIG. 6a;

FIG. 7a is a three-dimensional schematic view of an auxiliary cleaning member for a heavy work condition provided by an embodiment of this application;

FIG. 7b is a cross-sectional schematic view of the auxiliary cleaning member in FIG. 7a;

FIG. 8 is a schematic view for testing the cleaning effect corresponding to different steam flow capacities and numbers of times of cleaning for a light work condition provided by an embodiment of this application;

FIG. 9 is a schematic view for testing the cleaning effect corresponding to different steam flow capacities and numbers of times of cleaning for a medium work condition provided by an embodiment of this application;

FIG. 10 is a schematic view of a test region to be cleaned of a cooking range of a gas stove in a heavy work condition provided by an embodiment of this application;

FIG. 11 is a schematic view of comparison, when battery packs of different capacities are used for the region to be cleaned in the heavy work condition in FIG. 10 at different steam flow capacities through tests, between the time of endurance of the battery pack and the time of endurance of the battery pack actually required to meet the cleaning requirement;

FIG. 12 is a schematic view of the coordinates of the cleanable power per unit weight corresponding to different steam flow capacities for battery packs of different capacities when the whole machine weight is taken as a maximum boundary value in an embodiment of this application;

FIG. 13 is a schematic view of the coordinates of the cleanable power per unit weight corresponding to a steam flow capacity for battery packs of different capacities when the whole machine weight is taken as the minimum boundary value in an embodiment of this application;

FIG. 14 is a schematic view of the coordinates of the cleanable power per unit weight of a hand-held steam apparatus equipped with battery packs of different capacities that can meet the needs of a user in combination with FIG. 12 and FIG. 13.

FIG. 15a is a three-dimensional schematic view of a thick film heater of a hand-held steam cleaning apparatus provided by this application;

FIG. 15b is a side view of the thick film heater in FIG. 15a;

FIG. 16 is a three-dimensional exploded view of the thick film heater in FIG. 15a;

FIG. 17 is a cross-sectional view in the main view direction of a hand-held steam cleaning apparatus having a quartz tube heater when being not fitted with a battery pack provided by this application;

FIG. 18 is a partial cross-sectional schematic view of a hand-held steam cleaning apparatus having a quartz tube heater when being fitted with a battery pack provided by this application; and

FIG. 19 is a cross-sectional schematic view of the quartz tube heater in FIG. 17.

### DETAILED DESCRIPTION

A steam cleaning apparatus eliminates various stains on the surface to be cleaned by steam generated at high temperature, and at the same time eliminates various bacteria and micro-organisms, without using detergent, therefore being an efficient cleaning apparatus in line with the concept of environment friendliness.

Steam cleaning apparatuses on the market, including steam mops and cloth cleaners, are mainly used for indoor cleaning and all require a power line connected to a socket, i.e., corded tools, or AC (alternating current) power supply is used. Therefore, that the existing steam cleaning apparatus is difficult to move is a major problem for users, and the existing steam cleaning apparatus is not suitable for cleaning in outdoor scenarios, for example, cleaning outdoor furniture and equipment such as outdoor barbecues, and cleaning the interior of vehicles.

The reason why AC power supply is used for all the mature steam cleaning apparatuses is that, firstly, the design is less difficult, the corded design can easily achieve high power output and endurance of long time, and some of the technology can directly refer to traditional electric appliances with heating bodies, which are of course also corded, as AC power supply is used in both cases, there are no technical barriers in terms of electrical parameters or even model selection of circuit devices.

However, the steam cleaning apparatus is a cleaning tool in line with the concept of environmental protection and the demand for use of the steam cleaning apparatus also increases day by day, while the problems of AC tools being inconvenient to move and not suitable for outdoor scenarios are bound to fail to meet market expectations and demands for this type of product. There is still no product to solve the contradiction between energy and performance of the steam cleaning apparatus, and the choice of every parameter or component is a technical problem that urgently needs to be solved.

DC (direct current) power supply is a more flexible energy option and also a trendy technology in the fields of tools, unlike AC power supply, which makes moving difficult and restricts the use scenarios. With the rapid development of the new energy technology, battery packs, especially portable battery packs suitable for electric power tools, are increasingly being applied in all types of tools/household equipment. However, if the steam cleaning apparatus is to be powered by the battery pack, the problem of matching a cleaning module with an energy module have to be solved firstly.

In the conventional techniques, there is also a steam cleaning device that provides two modes of power supply, one is an external AC power supply and the other one is a plug-in removable direct current (DC) power supply. The user firstly heats water in a boiler to a certain temperature using the AC power source, and waits for a period of time before unplugging the AC power source, and then continues to heat the preheated water by the removable DC power source until steam is produced. The coexistence of the two power sources prolongs the time of endurance of the removable DC power source, but it is inconvenient for the user to switch operation between the different power source heating modes. Because there is no endurance limitation problem of the AC power source, a larger amount of water is heated at once using the boiler type heater, the time for the user to wait for production of steam is long, nowadays, cleaning device on the market that claims to be able to produce steam quickly will have to wait at least 30 seconds after starting the operation of the device to produce steam.

For a known hand-held cleaning tool, a power supply unit is disposed in a housing, and the capacity and voltage of the power supply unit is limited by the volume of the tool, usually leading to a short time of endurance. In order to improve the endurance, the capacity and voltage of the built-in power supply unit is expanded, leading to that the overall size and weight of the tool also increases significantly. According to a known mode, when the remaining power in the power supply unit is insufficient to support the continued operation of the hand-held cleaning tool, the power supply unit can be taken out and replaced with a power supply unit storing power to continue the cleaning operation, improving the endurance of the hand-held steam cleaning apparatus without increasing the weight of the hand-held steam cleaning apparatus. According to an alternative model, a battery pack is detachably combined with the main body of the steam cleaning apparatus and can be quickly replaced with a spare battery pack of the same specification when the battery pack is running low. Although the time of endurance of the steam cleaning apparatus can be prolonged in this mode, the user needs to pay extra costs to purchase the spare battery pack.

The technology of the battery pack used for tools is already relatively mature, and the steam cleaning apparatus, as a type of household tool, can even choose to borrow the existing battery pack directly from the household tool if it is powered by the battery pack, which is more economical, but this also poses a significant challenge to the design of the main body of the steam cleaning apparatus.

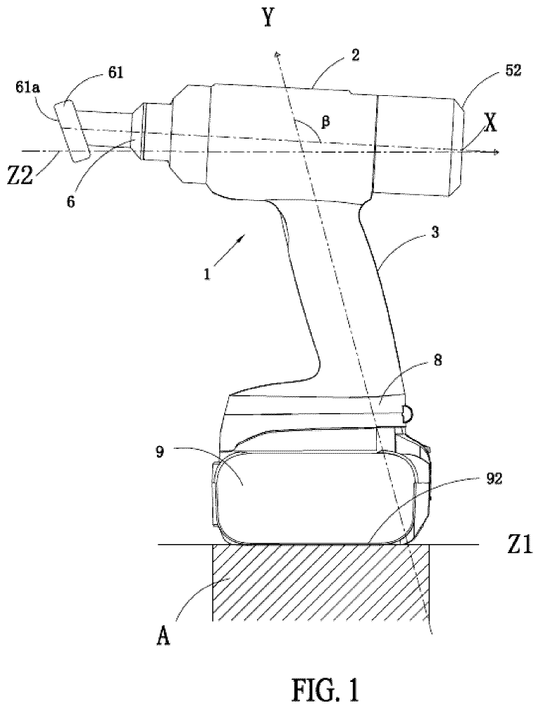

An embodiment of this application provides a cordless hand-held steam cleaning apparatus. The hand-held steam cleaning apparatus of the embodiment of this application is an apparatus which is suitable to be held by a user with one hand and is convenient to carry and move, specifically, the hand-held steam cleaning apparatus in the embodiment of this application is an apparatus that is operated with the weight of the apparatus completely borne by human hands. See FIG. 1 to FIG. 4 for details. Because the hand-held steam cleaning apparatus is the apparatus that is operated with the weight completely borne by human hands.

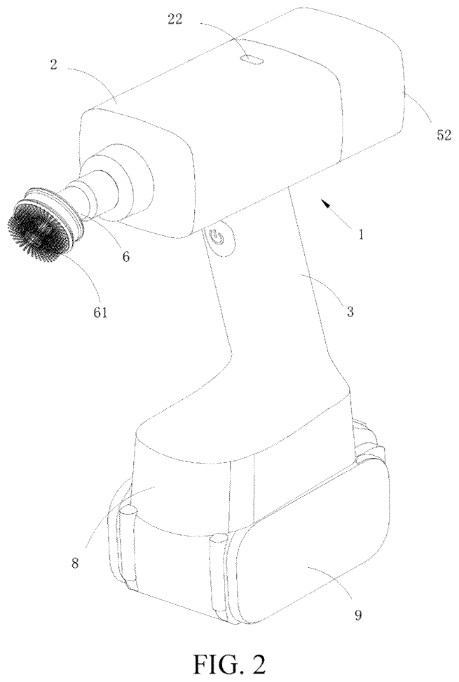

As shown in FIG. 1 and FIG. 2, a hand-held steam cleaning apparatus in an embodiment of this application includes a shell 1, the shell 1 having a main body 2 and a handle 3 connected to the main body 2; the free tail end of the handle 3 being provided with a mounting base 8, a battery pack 9 being detachably connected to the mounting base 8, and the bottom of the battery pack 9 being provided with a supporting surface 92. In a non-work state, when the hand-held steam cleaning apparatus is placed on a horizontal plane Z1 through the supporting surface 92, the hand-held steam cleaning apparatus can be stably and erectly supported on the horizontal plane Z1, the handle 3 is disposed vertically to be conveniently held by a user with one hand. The main body 2 has an extension axis X extends above the handle 3 in the transverse direction , the extension axis X of the main body 2 is disposed to slightly upwarp relative to a horizontal plane Z2 parallel to the horizontal plane Z1, facilitating smooth flowing of steam in a steam nozzle 6. The horizontal plane Z1 is actually a reference plane, in a specific working scenario, the reference plane may be tilted at a certain angle, but this does not affect the placement of the handheld steam cleaning device on the horizontal plane with the support surface 92 in a non-working state.

The main body 2 is provided with the steam nozzle 6 at one end of the extension axis X of the main body 2, an auxiliary brush head 61 is connected to the steam nozzle 6 in a matched mode, and the auxiliary brush head 61 is used, after the steam nozzle 6 sprays steam onto a surface to be cleaned, to wipe the surface to be cleaned to remove surface stains. The auxiliary brush head 61 can be disposed to be detachably connected to one end of the main body 2, so that the auxiliary brush head can be replaced with different auxiliary brush heads under different work conditions to be used for the surface to be cleaned made of different materials. In a non-work state, when the hand-held steam cleaning apparatus is placed on the horizontal plane through the supporting surface 92, a brush surface 61a of the auxiliary brush head 61 connected to the steam nozzle 6 in the matched mode is inclined approximately parallel to the axis Y of the handle, which allows the user to clean the surface of an object with the steam cleaning apparatus held in hand, especially when cleaning objects at a high position, without having to overturn the wrist excessively, thus making the cleaning work easier. An obtuse angle β is set between the extension axis X of the main body 2 and the axis Y of the handle to better improve the accessibility of the hand-held steam cleaning apparatus to the object to be cleaned, thus achieving a good man-machine use effect. The main body 2 is provided with an LED light 22 which can be used to indicate the working state of the hand-held steam cleaning apparatus.

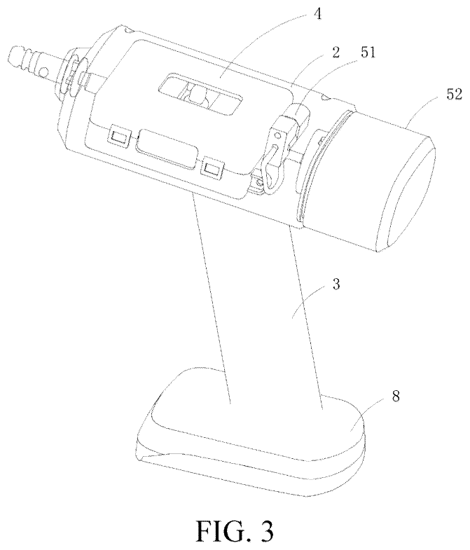

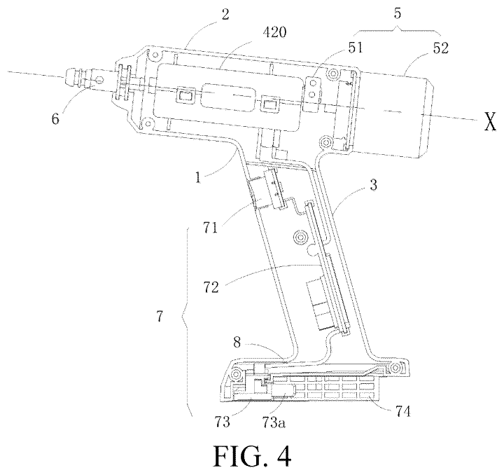

Referring to FIG. 3 and FIG. 4, the hand-held steam cleaning apparatus of this embodiment includes a steam generating unit 4 disposed inside the main body 2, the steam generating unit 4 having a housing 420; a water supply device 5 includes a water tank 52 and a water pump 51 capable of pumping the water in the water tank 52 into the steam generating unit 4; The water pump 51 of this embodiment is disposed in the main body 2, and the water tank 52 is disposed at the other end of the main body 2 with respect to the steam nozzle 6; the water tank 52, the water pump 51 and the steam generating unit 4 are arranged in a linear manner, thereby making the layout more compact, and also enabling the water in the water tank 52 to be directly pumped into the steam generating unit 4 via the water pump 51, the path of the water being shorter, and the steam production time being shorter. A control device 7 includes a control trigger 71 disposed at one end of the handle 3 close to the main body, and a circuit board 72 disposed in the handle 3; the control trigger 71 is electrically connected to the circuit board 72 and the battery pack 9. In response to the user's operation of the control trigger 71, the control device 7 controls the water pump 51 to deliver the water from the water tank 52 into the steam generating unit 4, and controls the steam generating unit 4 to perform heating. The mounting base 8 located at the free tail end of the handle 3 is provided with guide rails 74 in matched connection with the battery pack in a sliding mode and a conducive terminal 73, being used for detachable matched assembly with the battery pack 9. The hand-held steam apparatus provided by this application connected with the battery pack 9 in a matched mode is not limited by a power line, and is not only portable, but also convenient to move for application in a scenario in which there is no mains supply.

The instant steam generation referred to in this embodiment means that the user can start the cleaning work without waiting for almost no time since starting the cleaning apparatus, specifically, since the user triggers the control trigger 71, the steam can be ejected from the steam nozzle 6 in no more than 20 seconds. For household cleaning equipment, for example, it will be used twice or more in a week, the water pipe between the water tank 52 and the steam generating unit 4 may still retain a certain amount of water. In this case, steam can be emitted in no more than 10 seconds from the time the control trigger 71 is operated, so the user hardly needs to wait to start the cleaning work, so users hardly need to wait to start cleaning work. In one example, the handheld steam cleaning device is characterized in that the preheating time is not less than 2 seconds, and water enters the steam generating unit from the inlet of the steam generating unit to heat and vaporize the water flowing out from the outlet of the steam generating unit. The time T from the start of the water pump to the steam output from the steam nozzle satisfies 5 seconds≤T<20 seconds.

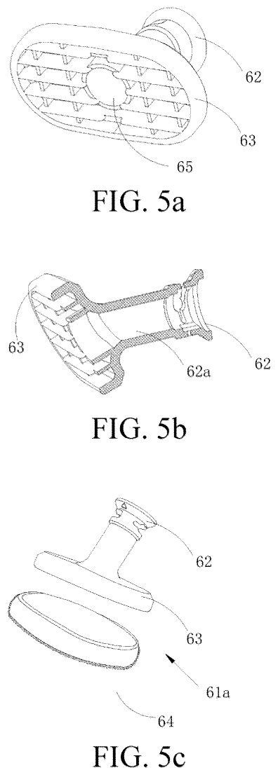

For the requirements of the surface to be cleaned in different scenarios, the embodiment of this application is provided with different auxiliary cleaning members. Referring to FIG. 5a, FIG. 5b, and FIG. 5c, an auxiliary cleaning member for a light work condition provided by an embodiment of this application, the auxiliary cleaning member including a flat plate brush 61a. A connection portion 62 is disposed at one end of the flat plate brush 61a and configured to detachably connect with the steam nozzle, and the other end of the flat plate brush is provided with a flat plate supporting surface 63, the flat plate supporting surface 63 is detachably sleeved with a cloth sleeve 65 for a direct contact with the surface to be cleaned, and the cloth sleeve can be made of cotton cloth, lint cloth, non-woven cloth or other materials suitable for a contact with smooth or soft surfaces such as leather. The connection portion 62 is provided with a hollow channel 62a, and the flat plate supporting surface is provided with a through hole 64 for communicating with the hollow channel 62a to allow steam sprayed from the steam nozzle 6 to be sprayed from the through hole 64 to the object to be cleaned via the channel 62a.

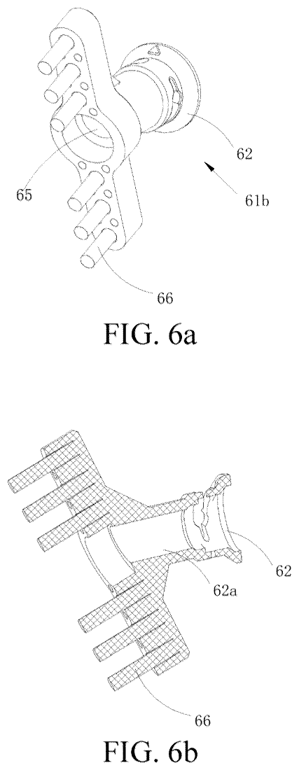

Referring to FIG. 6a and FIG. 6b, an auxiliary cleaning member for a medium work condition provided by an embodiment of this application, the auxiliary cleaning member including a nylon brush 61b, Accordingly, one end of the nylon brush 61b is provided with a connection portion 62 detachably connected with the steam nozzle 6, the nylon brush 61b is configured to assist in cleaning a smooth surface or a hard surface such as a toilet washstand or a kitchen table top, and the other end of the nylon brush 61b is provided with a part, being nylon wires 66, in contact with the surface to be cleaned.

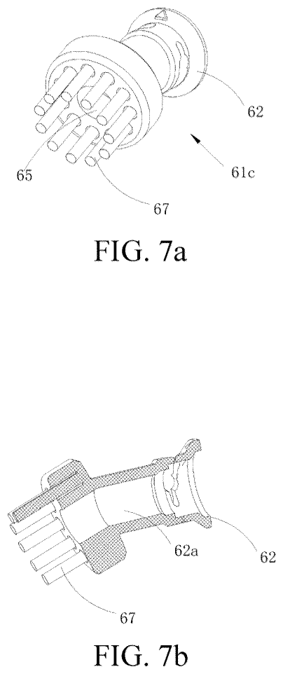

Referring to FIG. 7a and FIG. 7b, an auxiliary cleaning member for a heavy work condition provided by an embodiment of this application, the auxiliary cleaning member including a metal brush 61c, the metal brush 61c is configured to assist in cleaning the metal surface such as a cooking range of a gas stove in a kitchen, one end of the metal brush 61c is provided with a connection portion detachably connected with the steam nozzle 6, and the other end of the metal brush 61c is provided with a part, being metal wires 67, such as steel wires or copper wires, in direct contact with the surface to be cleaned. The connection portions of the flat plate brush 61a, the nylon brush 61b, and the metal brush 61c are disposed into the same matched-connection configuration so that the steam nozzle 6 can be in matched connection with the connection portions of the different auxiliary cleaning members; the shape of the brush head and the material of the part in contact with the surface to be cleaned can be adjusted and changed accordingly according to the requirements of the surface to be cleaned, and are not limited to the embodiment of this application. In practical operation, a user can choose different auxiliary brush heads for replacing use to assist the hand-held steam apparatus of this application in performing cleaning work according to different surfaces to be cleaned. The connection structure for matched connection of the auxiliary cleaning member 61 and the steam nozzle 6 can be disposed as threaded connection, and can also be snap-fit connection or other connection means, and different manners for the purpose that a user is able to quickly and reliably perform disassembling or mounting or connecting can be used in this application.

In the embodiment of this application, the battery pack uses a lithium ion (Li-ion) battery, lithium batteries have been widely used because they are light, large in capacity, free of memory effect and rechargeable. With the development of science and technology, the lithium batteries have become the mainstream. In some embodiments, the configuration of the battery pack 9 includes a plurality of battery cells, a shell for wrapping the battery cell, a conductive member connecting the battery cell and other control components such as a circuit board (not shown in the figures).

When the battery cells are the same, the voltage of the battery pack is related to the number of the battery cells. For example, the nominal voltage of each battery cell in the battery pack is 3.6 V, and when the voltage of the battery pack used is 10.8 V, the battery pack includes three battery cells; when the voltage of the battery pack used is 14.4 V, the battery pack includes four battery cells; when the voltage of the battery pack is 18 V, the battery pack includes five battery cells; when the voltage of the battery pack is 21.6 V, the battery pack includes six battery cells; when the voltage of the battery pack is 25.4 V, the battery pack includes seven battery cells; when the voltage of the battery pack is 28.8 V, the battery pack includes eight battery cells; when the voltage of the battery pack is 38 V, the battery pack includes ten battery cells, and so on. The voltage of the battery pack used in the embodiment of this application is not less than 10.8 V, and the voltage range is, for example, 14.4 V to 25.4 V.

The weight of the battery pack mainly includes the following parts: the weight of the battery cell, the weight of the control component and the weight of the shell. The shell of the battery pack is generally disposed as a plastic housing. At present, there is a soft-packed lithium battery on the market, which has advantages of good safety, light weight, small internal resistance, flexible design of the size and shape, fast charging and discharging, long charging and discharging cycle life, etc., and can also be applied to the hand-held steam cleaning apparatus of the embodiment of this application. The embodiment of this application does not limit the specific form of the battery pack. It can be understood that the higher the capacity of the battery pack, the larger the volume of the battery pack, and the higher the weight; the lower the capacity of the battery pack, the lighter the weight of the battery pack.

The above embodiment provides a hand-held steam cleaning apparatus which is compact and convenient to hold by designing the hardware layout. The DC hand-held apparatus is good in portability and convenient to move, facilitating cleaning in a variety of scenarios such as table tops and windowsills. The weight of the apparatus also needs to be factored into the design of the steam cleaning apparatus, given that the user needs to maintain holding the steam cleaning apparatus to complete the cleaning operation.

As a DC power supply, the battery pack, particularly the battery pack suitable for tools, is still in the technological development stage of continuously approaching the performance of an AC power source in terms of power supply performance. It can be understood that the higher the output voltage of the battery pack, the higher the capacity, the more the performance approaches to that of the AC power source, but this also means that the battery pack is heavier. The existing steam cleaning apparatus uses the AC power source for supplying power, can easily achieve high power output, and can support the large steam flow capacity output from the steam cleaning apparatus due to high power, the large steam flow capacity can be powerful to eliminate the stains to be cleaned, mould, etc., so as to achieve an effective cleaning effect, and the existing steam cleaning apparatus is connected to the mains supply through the power line to work, and the continuous work time is not limited by energy. In contrast, when DC is used for supplying power, the output power of the steam cleaning apparatus needs to take the performance of the power supply battery pack into account, and the continuous work time is also limited by the capacity of the battery pack. Due to the difference in power supply energy, the DC powered steam cleaning apparatus cannot refer to the design of the AC powered steam cleaning apparatus in many ways. Furthermore, as the battery pack itself is heavy, accounting for 32.8% to 67.8% of the total weight of the hand-held steam cleaning apparatus, and as the weight of the battery pack increases almost proportionally with the capacity, it is not possible to improve the performance of the steam cleaning apparatus by simply improving the performance of the battery pack, taking into account the impact of the weight of the battery pack on the whole machine weight. Therefore, the challenge of designing a cordless hand-held cleaning apparatus is how to balance the performance parameters of the steam cleaning apparatus with operational comfort (which is high influenced by weight) and how to maximize performance with limited supply of energy.

The following are some of several important parameters for measuring the performance of the steam cleaning apparatus.

Steam flow capacity: the average mass of steam sprayed per minute when the appliance works in a steady state under specified test conditions.

The steam flow capacity is indicated by M below, with the unit of g/min. The steam flow capacity is determined by the heating power, namely, the steam flow capacity is determined by the output power of the battery pack. The following is also referred to as the amount of steam produced per unit of time.

Continue work time: the time from the start of steam release to the end of steam under a normal work state.

The continue work time is indicated by T below, with the unit of min. The continue work time is also referred to as time of endurance, etc.

Steam temperature: the value of steam temperature of the appliance during continuous work under the specified test conditions.

Thermal efficiency: the ratio of the heat absorbed by the steam flow capacity to the electricity consumed in the process, measured under the specified conditions.

The experimental conditions include the standard atmospheric pressure (approximately 96 kPa to 106 kPa), an ambient temperature of (20±5) degrees Celsius and a water temperature of (20±5) degrees Celsius for the water to be heated. Unless otherwise specified below, the experimental data are measured under the above experimental conditions.

Given the limitations of the power supply capacity of the battery pack, the steam cleaning apparatus of this embodiment is primarily intended to address problems in light to medium work conditions of stains. Typical medium work conditions include the cleaning of objects such as kitchen table tops, furniture or windows. Typical light work conditions include the cleaning of objects such as leather, washstands, local stains or mold. The above scenarios are mainly fixed-point cleaning for local stains. The light work condition has the lowest requirement for the steam flow capacity and the continuous work time. In outdoor cleaning scenarios, most of the objects such as cars and outdoor furniture are cleaned under light or medium work conditions, so solving the problem of cleaning under light to medium work conditions can achieve most of the cleaning needs of the DC hand-held steam cleaning apparatus. Of course, the steam cleaning apparatus of this embodiment can also meet the cleaning needs under some heavy work conditions. The level of the work condition is a combination of factors such as the stubbornness of the stain, the contamination area and so on, and does not correspond absolutely to the object to be cleaned, for example, in the embodiment below, the stain in the cooking range of the gas stove belongs to one of the heavy work conditions. It can be understood that if the steam cleaning apparatus can meet the cleaning needs of the heavier work conditions, it can also meet the cleaning needs of other lighter work conditions.

### [Cleanable Power Per Unit Weight MT/G]

In cleaning tests on leather, washstands and cooking benches under various work conditions, it was found that stains generally require longer continuous work time to be removed at a lower steam flow capacity, while stains can be removed more quickly at a higher steam flow capacity, i.e., the continuous work time can be shorter. Therefore, the product of the steam flow capacity M and the continuous work time T represents an important parameter in terms of the cleaning power achievable by the apparatus. However, these parameters are highly dependent on the weight of the apparatus. The water tank and the battery pack form the largest part of the weight of the apparatus. The weight of the battery pack is essentially in direct proportion to the capacity, while the volume of the water tank is also influenced by the capacity of the battery pack (described in detail below). It can be said that the capacity of the battery pack determines the weight level of the apparatus. The capacity of the battery pack also determines the steam flow capacity and the continuous work time. The capacity of the battery pack should not be too large as this will result in a reduction in the operability of the apparatus. In other words, we want to have higher cleanable power of the apparatus, but we also want to limit the weight of the apparatus, while the cleanable power is influenced by the weight of the apparatus, especially the weight of the battery pack. The weight of the battery pack is indicated by G below. The ideal situation is to have a higher MT output per unit of G. In this way, it is also possible to have a higher value of MT while G is limited, so the ratio of MT to G is an important parameter to measure the overall performance of the product, which we call the cleanable power per unit of weight, i.e., the ratio of the cleanable power to the weight (MT/G).

Of course, to obtain an ideal MT/G value, design in many aspects is required, including the design of the battery pack, the design of the heating body, steam parameters, electrical parameters, and the matching relationship between the various components and parameters, etc.

### [Steam Flow Capacity]

It is known from the above that the steam flow capacity M is an important parameter in evaluating the cleaning power of the steam cleaning apparatus. Considering the limitations of the power supply capacity of the battery pack, the steam flow capacity of a DC hand-held steam cleaning apparatus needs to be set to a reasonable value so that it can meet the requirement for the cleaning power in light to medium work conditions while matching a DC power source, allowing the battery pack to support the performance of the steam cleaning apparatus. It can be understood that the higher the steam flow capacity, the greater the cleaning power for stains, but also the greater the energy consumption, so determining the most basic steam flow capacity to meet the demands in a particular work condition is an important issue to be addressed in this embodiment.

Test data for several typical work conditions are shown below.

The effect of fixed-point cleaning is shown below. The number of times for repeatedly wiping a place should not be too large, otherwise it will easily cause damage to the surface being wiped. The number of times to wipe flexible surfaces such as leather and cloth generally should not exceed 3 times, while the number of times to wipe the hard surfaces can be properly increased to 4 or 5 times, etc.

### Work Condition 1: Leather

The area of a fixed-point cleaning test region is approximately 75 mm*75 mm and the stains are mixed stains of ketchup and oyster sauce. The steam nozzle 6 matched with the flat plate brush 61a performs reciprocating wiping once, i.e., cleaning once, while spraying steam on the surface of the stain, up to a maximum of 3 times.

The effects of the steam flow capacity of 2 g/min, 2.5 g/min and 3 g/min in combination with different numbers of cleaning times are shown below:

In the embodiment of this application, the ratio of the area of the cleaned surface after wiping to the area of the surface before being cleaned is measured and defined as the apparent density, the higher the value of the apparent density, the higher the degree of cleaning. The cleaning effect on the leather is reflected by the steam flow capacity and the number of times of wiping in contrast with the apparent density, with reference to Table 1 below.

TABLE 1
Test data for cleaning leather stains with steam

| Steam flow capacity | | | |
|---|---|---|---|
| Apparent density | | | |
| Number of | | | |
| times of cleaning | 2 g/min | 2.5 g/min | 3 g/min |
| once | 3% | 5% | 15% |
| twice | 9% | 13% | 49% |
| Three times | 20% | 29% | 95% |

Table 1 shows that when the steam flow capacity is set at 2 g/min and 2.5 g/min, the apparent density changes slightly after cleaning once, twice and three times, and the apparent density after cleaning three times is less than 30%. When the steam flow capacity is adjusted to 3 g/min, the apparent density after the first-time cleaning is 15%, and the apparent density after the second-time cleaning is 49%, close to 50%; after the third-time cleaning, the apparent density reaches 95%, which can basically meet the requirement for fixed-point cleaning of leather sofa. By analogy, the greater the steam flow capacity, the better the cleaning effect, and the less the number of times of cleaning. It can be obtained that the cleaning effect is not good when steam flow capacity is less than 3 g/min. When the steam flow capacity reaches 3 g/min, the stains on the leather sofa or seat can be cleaned without damaging the leather material.

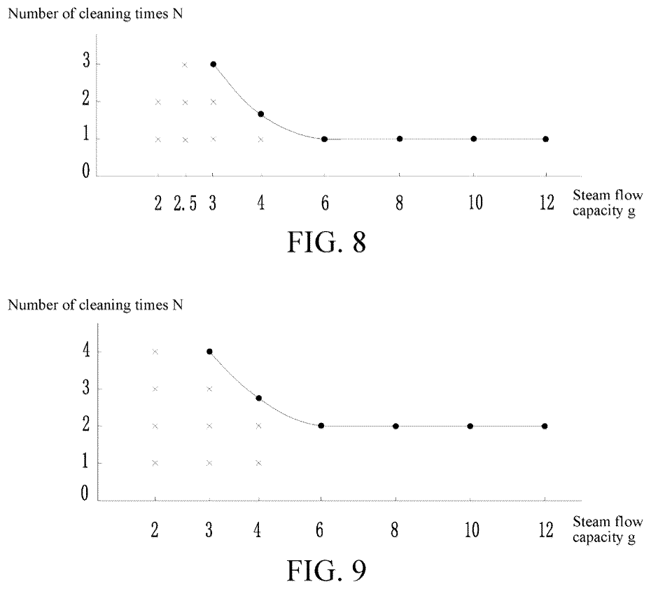

Further referring to FIG. 8, it can be seen that with the increase of the steam flow capacity, the number of times of cleaning tends to decrease. In the figure, the symbol “●” indicates the completion of cleaning, and the symbol “x” indicates that cleaning cannot be completed. It can be seen that when the steam flow capacity reaches 6 g/min and above, cleaning can be easily completed after cleaning is performed only once.

### Work Condition 2: Washstand

The area of a fixed-point cleaning test region is 25 mm*25 mm, and the stains are liquid soap and toothpaste marks accumulated for a long time on the washstand surface.

The steam nozzle 6 matched with the nylon brush 61b performs reciprocating wiping once, i.e., cleaning once, while spraying steam on the surface of the stain.

The cleaning effects of the steam flow capacity of 2 g/min, 2.5 g/min and 3 g/min in combination with different numbers of cleaning times are shown below:

The cleaning effect on the washstand surface is reflected by the steam flow capacity and the number of times of cleaning in contrast with the apparent density, with reference to Table 2 below.

TABLE 2
Test data for cleaning washstand stains with steam

| Steam flow capacity | | | |
|---|---|---|---|
| Apparent density | | | |
| Number of | | | |
| times of cleaning | 2 g/min | 2.5 g/min | 3 g/min |
| once | 3% | 4% | 33% |
| twice | 9% | 21% | 67% |
| Three times | 18% | 14% | 94% |
| Four times | 39% | 58% | 100% |

When the steam flow capacity is 2 g/min and 2.5 g/min for wiping, after 4 times of wiping and cleaning, the effect is not ideal, and there are still a lot of white stains left; when the steam flow capacity is adjusted to 3 g/min, after 4 times of reciprocating wiping, an ideal effect can be obtained, and the white stains can be basically wiped clean. In the questionnaire survey, most users reflect that when the local stubborn dirt on the table top is cleaned, reciprocating wiping needs to be performed for seven or eight or more times, while it is available through the experimental test that the steam cleaning apparatus can be used for wiping for four times to obtain the ideal effect. As can be seen, 3 g/min is the steam flow capacity which can meet the user's cleaning requirements.

Further referring to FIG. 9, it can be seen that with the increase of the steam flow capacity, the number of times of cleaning tends to decrease, and when the steam flow capacity reaches 6 g/min and above, cleaning can be easily completed after cleaning is performed twice.

### Work Condition 3: Cooking Bench

The area of a fixed-point cleaning test region is approximately 25 mm*25 mm and the stains are mixed stains of oil stains, soybean sauce and the like. The steam nozzle 6 matched with the metal brush 61c performs reciprocating wiping once, i.e., cleaning once, while spraying steam on the surface of the stain.

The cleaning effects of the steam flow capacity of 2 g/min, 2.5 g/min and 3 g/min in combination with different numbers of cleaning times are shown below:

The cleaning effect on the cooking bench is reflected by the steam flow capacity and the number of times of cleaning in contrast with the apparent density, with reference to Table 3 below.

TABLE 3
Test data for cleaning stains of the cooking
bench in a kitchen with steam

| Steam flow | | | |
|---|---|---|---|
| capacity | | | |
| Apparent density | | | |
| Number of | | | |
| times of cleaning | 2 g/min | 2.5 g/min | 3 g/min |
| once | 6% | 5% | 15% |
| twice | 13% | 17% | 37% |
| Three times | 29% | 31% | 68% |
| Four times | 36% | 37% | 89% |
| Five times | 45% | 49% | 100% |

It can be seen from Table 3 that when the steam flow capacity is set at 2 g/min and 2.5 g/min, the apparent density increases slowly when cleaning is performed from once to five times, and the apparent density after cleaning is performed for five times is less than 50%. When the steam flow capacity is adjusted to 3 g/min, the apparent density after cleaning is performed for four times is 89%, and the apparent density after cleaning is performed for five times basically reaches 100%. It can be concluded that for moderate stains such as oil stains and rust spots, the steam flow capacity of 3 g/min achieves a satisfactory cleaning effect.

Analysis of the test data shows that even in the light work condition, the steam flow capacity greater than or equal to 3 g/min is required for effective cleaning. With the steam flow capacity greater than or equal to 3 g/min, most cleaning problems in light to medium work conditions can be solved. Therefore, 3 g/min is considered to be the threshold of the steam flow capacity for the steam cleaning apparatus to meet the cleaning performance requirements.

The steam flow capacity M is in direct proportion to the power P of the steam generating unit, the higher the power P of the steam generating unit, the higher the steam flow capacity M. As the power P increases, for the battery pack with a given capacity Q, the time of endurance T of the single pack will be correspondingly smaller. Therefore, when the steam flow capacity M needs to be increased and the power P needs to be increased, the capacity Q of the battery pack is bound to increase in order not to reduce the time of endurance T of the single pack. This means that there is a higher requirement for the capacity Q of the battery pack.

### [Continuous Work Time]

With the reasonable steam flow capacity capable of achieving the cleaning effect, enabling the continuous work time of the steam cleaning apparatus to meet the cleaning requirements is also a performance condition required to be guaranteed. As mentioned above, the continuous work time of the steam cleaning apparatus refers to the time from the start of steam injection to the end of steam injection in a normal work state. In the case of an AC powered apparatus, the time during which the apparatus produces the steam is mainly limited by the capacity of water accommodated in the water tank, as the energy supply is not restricted. For a DC powered apparatus, the main constraint on the continuous work time of the apparatus is the capacity of the battery pack. This is because the impact of increasing the capacity of the battery pack on the apparatus (mainly, the impact on the weight) is much more significant than the impact of increasing the capacity of the water tank on the apparatus. In this embodiment, the volume of the water tank is designed so that the water supply amount of the water tank when filled with water meets the requirement of the amount of water consumed in the process when the battery pack is discharged once. The time during which the battery pack is discharged once refers to the time of the interval from the start of work of the battery pack when being fully charged to the stop of work when the battery pack is discharged to the protection threshold. The continuous work time of the steam cleaning apparatus is limited by the time during which the battery pack is discharged once. In this embodiment, when the steam cleaning apparatus is turned on and the battery pack starts to supply power, the apparatus first enters the pre-heating process and starts to produce steam after completing the pre-heating until the battery pack is discharged to the protection threshold and the apparatus stops producing steam. In this embodiment, the continuous work time of the steam cleaning apparatus is not greater than the time during which the battery pack is discharged once. The longer the time during which the battery pack is discharged once, the longer the continuous work time of the steam cleaning apparatus. If the time during which the battery pack is discharged once is too short, the steam cleaning apparatus will not be able to complete the cleaning of the stains within the continuous work time and will need to recharge the battery pack again, which will inevitably cause inconvenience to the use of the apparatus and will not meet the basic cleaning requirements.

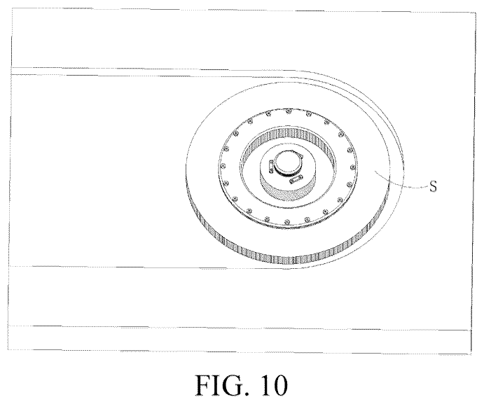

In order to determine whether the continuous work time of the steam cleaning apparatus can meet the cleaning requirements, in this embodiment, cleaning of the cooking range of the gas stove in a heavy work condition is determined as the test scenario. Because the stains of the cooking range belong to stains in a heavy work condition, if the steam cleaning apparatus is able to meet the cleaning needs of the cooking range, it is assumed that the steam cleaning apparatus can also meet the cleaning needs in other light to medium work conditions As shown in FIG. 10, the stains of the cooking range are usually represented by a circle of stains along the periphery of the cooking range, i.e., an annular region marked S in the figure is the region to be cleaned, and the stains of the cooking range are caused by cooking spills or spatters, etc.

The continuous work time that can be achieved by the steam cleaning apparatus at a given steam flow capacity is related to the capacity of the battery pack which the steam cleaning apparatus is equipped with. In this embodiment, in the test to determine whether the continuous work time of the steam cleaning apparatus meets the cleaning requirements, battery packs with a number of battery capacities were used, as shown in Tables 4-6 below. In this embodiment, tests were conducted with a battery pack of an 18 V voltage platform, which can achieve different capacities depending on different Ah values, commonly including 1.5 Ah, 2 Ah, 4 Ah, etc. For example, 1.5 Ah corresponds to a capacity of 27 Wh, 2 Ah corresponds to a capacity of 36 Wh, 4 Ah corresponds to a capacity of 72 Wh, etc. The battery pack of the 18 V voltage platform is also common in other household electric power tools, and if the battery pack is used to supply power for the steam cleaning apparatus, the battery pack can be shared. It can be understood that in order to achieve the same performance effect in the parameter design of the steam cleaning apparatus of this embodiment, it is also possible to use battery packs of other voltage platforms, such as 36 V, 72 V, etc. These battery packs can also achieve the same power supply capacity as the battery pack of the 18 V voltage platform as described above, provided that the battery packs have the same capacity grade. The weight of the battery pack is mainly related to the capacity of the battery pack, and the weight grade of the battery pack corresponds to the capacity grade of the battery pack when the performance of battery cells is certain.

Specifically, The test conditions are as follows: a variety of cooking ranges of the same specification were selected, the region to be cleaned was within the region defined by Φ190 mm and Φ120 mm and the surface thereof was coated with aged oil stains (5 g), the surface thereof was blown for 0.5 h by using a similar tool capable of blowing hot air such as a hair dryer (low speed level), and then the surface thereof was coated with a mixture of soybean sauce and oyster sauce (10 g) and blown with the same hot air for 0.5 h and then left to stand for 2 days. The test was carried out in a laboratory environment at 22-25 degrees Celsius and humidity of 60-70%, with the water tank filled with water at 22 degrees Celsius.

According to the test process: the steam cleaning apparatus was fitted with a metal brush, and turned on until steam is produced, brushing the dirty region of the cooking range in a reciprocating mode while spraying steam to the dirty region of the cooking range, with continuous operation of about 1 min, and then stopped, the brushed region was wiped clean with cleaning cloth, then the steam producing and reciprocating brushing action was repeated for the unclean region, and the user judged when the cleaning cloth is needed for wiping on his/her own according to the cleaning effect until the surface was clean or the apparatus stopped producing steam. The time of spraying steam each time is recorded and the sum of the time for spraying steam each time is the steam spray time. The tests were conducted several times, and each test is based on essentially the same work condition of contamination and operated by the same operator. The combined results of the tests conducted several times are recorded.

Although 3 g/min is a minimum value for the steam flow capacity as measured by the tests, the need for a higher steam flow capacity needs to be considered when designing the performance of the apparatus. As a product, different steam flow capacities may be set according to different grades of the product, or the user may be provided with an adjustable choice. In this embodiment, tests were also conducted for a number of conditions with the steam flow capacity greater than 3 g/min, specifically as shown in Table 4.

It can be understood that the greater the capacity of the battery pack, the longer the continuous work time that can be achieved by the steam cleaning apparatus at a given steam flow capacity. Therefore, in this embodiment, the test method is as follows.

First, a battery pack of a greater capacity was selected for performing the test to obtain data on the continuous work time required to meet the cleaning requirements at different steam flow capacities. Specifically, a battery pack of 72 Wh was firstly used for performing the test. The steam flow capacities are adjusted to 3 g/min, 4 g/min, 5 g/min, 7 g/min, 9 g/min, 11 g/min, 12 g/min and 13 g/min respectively. The test conditions and procedure are as described above. With the steam flow capacity of 3 g/min as an example, the steam injection time is 12.1 min, the stains of the cooking range were basically cleaned. This indicates that the cleaning task in this scenario can be completed by the combination of the parameters of the steam flow capacity and the continuous work time.

A comparison of the results before and after cleaning the stains of the cooking range is shown below.

In this test, the apparatus was able to clean the stains of the cooking range at the set steam flow capacity. The time taken from the time of steam production to the time when the object is cleaned for the test performed each time was recorded as the value of the continuous work time (T′) and test data was recorded in Table 4.

The test was then performed by using battery packs of smaller capacities, specifically, battery packs of 27 Wh and 36 Wh were respectively used for performing the test. The test was also carried out in a laboratory environment at 22-25 degrees Celsius and humidity of 60-70%, with the water tank filled with water at 22 degrees Celsius. The continuous work time that can be achieved by the apparatus at the same steam flow capacity, i.e., the time of the apparatus from the start of steam production to the stop of steam production, was recorded as the value of the continuous work time and test data was recorded in Tables 5 and 6.

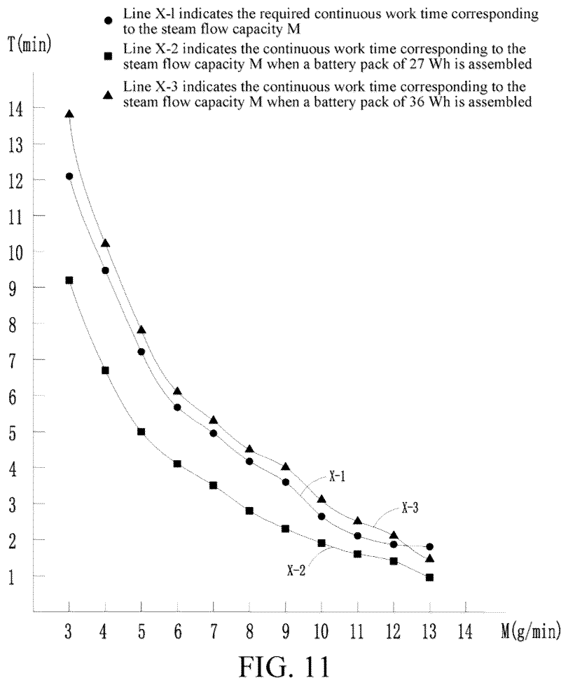

The data in Tables 4, 5 and 6 above were plotted on a graph with the steam flow capacity as the horizontal axis and the continuous work time as the vertical axis, as shown in FIG. 11. The data in Tables 4, 5 and 6 are joined into lines corresponding to lines X-1, X-2 and X-3 respectively.

We have already known that the line X-1 indicates the continuous work time required to completely clean the stains of the cooking range. So, if the values on the lines X-2 and X-3 are greater than the corresponding value on the line X-1, that is, if the value of the continuous work time (ordinate) that can be achieved by the apparatus at the same steam flow capacity (abscissa) is greater than the value on the line X-1, it shows that the continuous work time under these test conditions is able to meet the cleaning requirements. In other words, the cleaning performance of the steam cleaning apparatus equipped with the battery pack can meet the cleaning requirements. That is, the battery pack of the capacity is capable of providing the electrical energy capable of meeting the cleaning requirements at the set steam flow capacity.

As can be seen from FIG. 11, when the steam flow capacity is greater than 12 g/min, for example, up to 13 g/min, the continuous work time is too short to meet the cleaning requirements. Since the steam flow capacities below 12 g/min are sufficient to meet the cleaning requirements under various work conditions, the steam flow capacities above 12 g/min will result in a reduction in cleaning power. In other words, with the same capacity of the battery pack, if the steam flow capacity becomes greater, the continuous work time will become shorter and the overall cleaning power will be reduced. Therefore, 12 g/min is considered to be the threshold of the steam flow capacity for achieving high cleaning power.

TABLE 4
Test data obtained when the battery pack of 72 Wh was assembled

| M/(g/min) | 3 | 4 | 5 | 6 | 7 | 8 | 9 | 10 | 11 | 12 | 13 |
|---|---|---|---|---|---|---|---|---|---|---|---|
| T/min | 12.1 | 9.5 | 7.3 | 5.7 | 5 | 4.1 | 3.6 | 2.7 | 2.2 | 1.9 | 1.8 |

TABLE 5
Data of the continuous work time under different steam flow
capacities when a battery pack of 27 Wh was assembled

| M/(g/min) | 3 | 4 | 5 | 6 | 7 | 8 | 9 | 10 | 11 | 12 | 13 |
|---|---|---|---|---|---|---|---|---|---|---|---|
| T/min | 9.2 | 6.7 | 5 | 4.1 | 3.5 | 2.8 | 2.3 | 1.9 | 1.6 | 1.4 | 0.95 |

TABLE 6
Data of the continuous work time under different steam flow
capacities when a battery pack of 36 Wh was assembled

| M/(g/min) | 3 | 4 | 5 | 6 | 7 | 8 | 9 | 10 | 11 | 12 | 13 |
|---|---|---|---|---|---|---|---|---|---|---|---|
| T/min | 13.8 | 10.2 | 7.8 | 6.1 | 5.3 | 4.5 | 4 | 3.1 | 2.5 | 2.1 | 1.45 |

### [Cleanable Power MT]

As can be seen from the data in Table 4 (or see line X-1), the smaller the steam flow capacity, the longer the continuous work time required to completely clean the stain, while the greater the steam flow capacity, the shorter the continuous work time required to completely clean the stain. The steam flow capacity and the continuous work time are a set of interrelated parameters. When the steam flow capacity meets performance requirements, cleaning with steam within certain time is required to completely clean the stain. It can be considered that the cleaning power is the cumulative effect of the steam flow capacity over time, and therefore the product of the steam flow capacity and the continuous work time is considered to be an important parameter in measuring the cleaning power of the steam cleaning apparatus.

As known from the above, the data in Table 6 corresponds to the configuration of the parameters of the steam flow capacity and the continuous work time under the minimum configuration that can meet the performance requirements of the steam cleaning apparatus in this embodiment. What can be further derived from the data in Table 6 is the value of the MT product at each steam flow capacity, i.e., the value of the parameter that reflects the cleanable power of the apparatus under the minimum configuration that meets the performance requirements of the steam cleaning apparatus. It is specifically as shown in Table 7.

TABLE 7
Data of the MT product under different steam flow capacities
when a battery pack of 36 Wh was assembled

| M/(g/min) | 3 | 4 | 5 | 6 | 7 | 8 | 9 | 10 | 11 | 12 | 13 |
|---|---|---|---|---|---|---|---|---|---|---|---|
| MT/(g) | 41.4 | 40.8 | 39 | 36.6 | 37.1 | 36 | 36 | 31 | 27.5 | 25.2 | 18.85 |

As can be seen from the data in Table 7, the MT product tends to decrease as the steam flow capacity increases. This is because the MT is related to the discharge efficiency of the battery pack. Although the battery packs used have the same capacity, the battery packs are different in output electricity from the time when the battery pack is fully charged to the time when the battery pack is discharged to the protection threshold. The voltage at which the battery pack is discharged to the protection threshold is referred to as the cut-off voltage. The higher the output power required by the apparatus, the higher the discharge cut-off voltage of the battery pack and the less the discharged power, i.e., the discharge efficiency is low. The discharge efficiency is expressed as η1, η1=Qdischarge/Q, where, Qdischarge indicates the power discharged when the battery pack is discharged once, and Q indicates the total capacity of the battery pack. Therefore, when the steam flow capacity is small, due to the low power of the apparatus, the discharge efficiency of the battery pack is high, and therefore the MT product is great. When the steam flow capacity is great, due to the high power of the apparatus, the discharge efficiency of the battery pack is low, and therefore the MT product is small.

In this embodiment, under the minimum configuration meeting the performance requirements of the steam cleaning apparatus, 12 g/min is considered to be the threshold of the steam flow capacity to achieve higher cleaning power. The MT product is in the range of 25.2-41.4 (g), which means that the lower limit of the MT product is in the range of 25.2-41.4 (g).

Referring to Table 8 below, it shows data of the continuous work time T and the MT product with the steam flow capacities of 3 g/min, 4 g/min, 5 g/min, 7 g/min, 9 g/min, 11 g/min, 12 g/min and 13 g/min when the battery pack of 72 Wh was used for supplying power.

TABLE 8
Data of the MT product under different steam flow capacities
when the battery pack of 72 Wh was assembled

| M/(g/min) | 3 | 4 | 5 | 6 | 7 | 8 | 9 | 10 | 11 | 12 | 13 |
|---|---|---|---|---|---|---|---|---|---|---|---|
| T/min | 27.6 | 20.7 | 16.6 | 13.8 | 11.8 | 10.4 | 9 | 7.8 | 6.9 | 6 | 5.3 |
| MT/(g) | 82.8 | 82.8 | 83 | 82.8 | 82.6 | 83.2 | 81 | 78 | 75.9 | 72 | 68.9 |

Therefore, 12 g/min is considered to be the threshold of the steam flow capacity to achieve higher cleaning power. The MT product is in the range of 72-82.8 (g).

Referring to Table 9 below, it shows the data of the continuous work time T and the MT product with the steam flow capacities of 3 g/min, 4 g/min, 5 g/min, 7 g/min, 9 g/min, 11 g/min, 12 g/min and 13 g/min when the battery pack of 108 Wh was used for supplying power.

TABLE 9
Data of the MT product under different steam flow capacities
when the battery pack of 108 Wh was assembled

| M/(g/min) | 3 | 4 | 5 | 6 | 7 | 8 | 9 | 10 | 11 | 12 | 13 |
|---|---|---|---|---|---|---|---|---|---|---|---|
| T/min | 41.4 | 31.1 | 24.9 | 20.7 | 17.8 | 15.5 | 13.8 | 12 | 10.5 | 9.3 | 8.1 |
| MT/(g) | 124.2 | 124.4 | 124.5 | 124.2 | 124.6 | 124 | 124.2 | 120 | 115.5 | 111.6 | 105.3 |

Therefore, 12 g/min is considered to be the threshold of the steam flow capacity to achieve higher cleaning power. The MT product is in the range of 111.6-124.2 (g).

### [Cleanable Power Per Unit Weight MT/G]

As we have already known, the capacity Q of the battery pack directly affects the weight of the battery pack, and the weight of the battery pack is the most important factor affecting the whole machine weight of the hand-held steam cleaning apparatus. Therefore, in the case of determining the power supply capacity of the battery pack required to meet the cleaning performance requirements of the steam cleaning apparatus, the weight grade of the whole steam cleaning apparatus is determined, and thus the ratio of the cleanable power to the weight of the apparatus can be determined.

In this embodiment, as previously described, when various compact and lightweight designs are taken into account, the weight of the main body of the steam cleaning apparatus (without the water tank) is about 0.55 Kg, and the weight of the water tank when filled with water is about 146 g.

The water tank filled with water is another major component of the whole machine that increases the weight of the apparatus, apart from the battery pack. The time of endurance of a conventional steam cleaning apparatus is not limited by the electricity quantity, so the water tank is often designed to be large in order to reduce the frequency of adding water, and then the weight of the water tank when filled with water will be large. In this embodiment, the volume of the water tank is designed to match the capacity of the battery pack, so that the duration from the time when the apparatus works after the water tank is filled with water to the time when the water tank needs to be refilled is basically the same as the duration from the time when the apparatus works after the battery pack is fully charged to the time when the battery pack needs to be recharged, so that both the situation that when the capacity of the water tank is so small, the water tank needs to be refilled frequently, and the situation that when the capacity of the water tank is so large, the whole machine weight increases are avoided.

Table 10 below shows the weight of the battery packs with different capacities, and the whole machine weight.

It is known from the above that in this embodiment, the capacity Q of the battery pack is 36 Wh under the minimum configuration to meet the performance requirements of the steam cleaning apparatus, correspondingly, the weight of the battery pack is about 0.3 Kg to 0.55 Kg. At this moment, the total weight of the apparatus is about 0.916 Kg to 1.166 Kg.

It is known from the above that when the battery pack of 36 Wh is used for supplying power, the lower limit range for the product MT of the steam flow capacity M and the continuous work time T is 25.2-41.4 (g). Therefore, correspondingly, the lower limit range for the ratio of the cleanable power to the weight of the steam cleaning apparatus is:

$$MT / G = 0.0 \; 216 - 0.0452$$

In other words, to meet the basic performance of the steam cleaning apparatus, MT/G≥0.0216.

When the parameters of the steam flow capacity M and the continuous work time T of the apparatus are smaller, although the requirement for the power supply capacity of the battery pack will be reduced, thus allowing the whole machine weight to be reduced, the combination of the parameters of a too small steam flow capacity M and the continuous work time T will make the cleaning power of the apparatus not able to meet the requirements, thus failing to meet the basic performance of the steam cleaning apparatus.

When the parameters of the steam flow capacity M and the continuous work time T of the apparatus are larger, then a battery pack of a larger capacity Q is required to support the energy supply, and the battery pack of a larger capacity means a larger whole machine weight. The weight of the battery packs and the whole machine weight corresponding to battery packs of different capacities are as shown in Table 10.

In the market research on the weight of the hand-held steam cleaning apparatus that is acceptable for the user, the feedback of the users for the different weights of the apparatus is as follows: in the research on the whole machine weight less than 2 Kg, 90% of the personnel felt good when using the steam cleaning apparatus for 15 minutes or less, when the weight was increased to 2.2 Kg or more, the acceptability of the user for the weight decreased significantly, and only 10% of the personnel may insist on using the steam cleaning apparatus for 15 minutes. Therefore, battery packs with large capacities, especially battery packs with the capacity larger than 144 Wh, can significantly reduce the user comfort when using the hand-held steam cleaning apparatus and are therefore not an ideal choice for energy supply.

TABLE 10
Comparison of the capacity of the battery pack
with the weight thereof and the whole machine weight

| Capacity/ | Weight of the | Whole machine |
|---|---|---|
| Wh | battery pack/Kg | weight/Kg |
| 27 | 0.3-0.45 | 0.916-1.066 |
| 36 | 0.3-0.55 | 0.916-1.166 |
| 72 | 0.6-0.87 | 1.216-1.486 |
| 90 | 0.6-0.87 | 1.216-1.486 |
| 108 | 0.65-1.1 | 1.266-1.716 |
| 144 | 0.95-1.3 | 1.566-1.916 |

Assuming a battery pack of 144 Wh as the upper limit condition of the power supply capacity of the DC-style hand-held steam cleaning apparatus, data of the steam flow capacity and the continuous work time of the steam cleaning apparatus tested under this condition are as shown in Table 11 below.

TABLE 11
Data of the continuous work time and the MT product under different
steam flow capacities when the battery pack of 144 Wh was assembled

| M/(g/min) | 3 | 4 | 5 | 6 | 7 | 8 | 9 | 10 | 11 | 12 | 13 |
|---|---|---|---|---|---|---|---|---|---|---|---|
| T/min | 55.3 | 41.4 | 33.2 | 27.6 | 23.7 | 20.7 | 18.4 | 16.2 | 14.6 | 12.9 | 11.3 |
| MT/(g) | 165.9 | 165.6 | 166 | 165.6 | 165.9 | 165.6 | 165.6 | 162 | 160.6 | 154.8 | 146.9 |

Therefore, 12 g/min is considered to be the threshold of the steam flow capacity to achieve higher cleaning power. From the data in Table 11, the upper limit range of the product MT of the steam flow capacity M and the continuous work time T is 154.8 to 166. When the battery pack of 144 Wh is used for supplying power, the weight of the battery pack is 0.95-1.3 Kg and the whole machine weight is in the range of 1.566-1.916 Kg, with the whole machine weight not exceeding 2.0 Kg, which is within the range of the acceptable weight of the hand-held steam cleaning apparatus tested. Therefore, the upper limit range of the ratio MT/G of the cleanable power to the weight of the apparatus is:

$$MT / G = 0.0 \; 808 - 0.106$$

In other words, to reach the acceptable level for the hand-held steam cleaning apparatus, MT/G≤0.1060.

In summary, the MT value fluctuates with the steam flow capacity changing when the battery pack of each specification supplies power, as the weight of the battery pack of each specification fluctuates within a certain range, so the whole machine weight G matching battery packs of different capacities also fluctuate within a certain range. Thus, in the case where the battery pack of each specification supplies power, the cleanable power per unit weight MT/G has maximum and minimum boundary values within the range determined by the threshold of the steam flow capacity, and has different boundary values as the weight of the battery pack fluctuates.

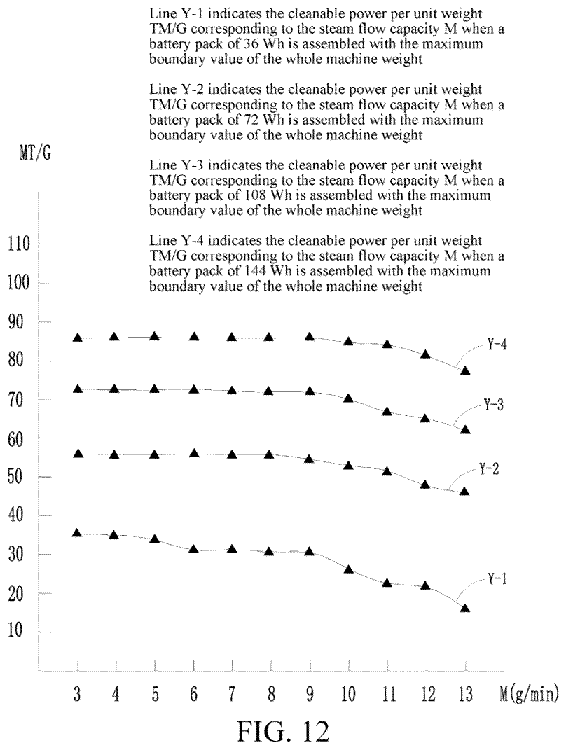

Referring to FIG. 12, when the capacities of the battery packs are 36 Wh, 72 Wh, 108 Wh and 144 Wh respectively, the cleanable power per unit weight MT/G of the hand-held steam cleaning apparatus is calculated using the minimum boundary value of the weight of the battery pack, and lines marked Y-1, Y-2, Y-3 and Y-4 are obtained to represent MT/G values when matching the battery packs of different capacities respectively.

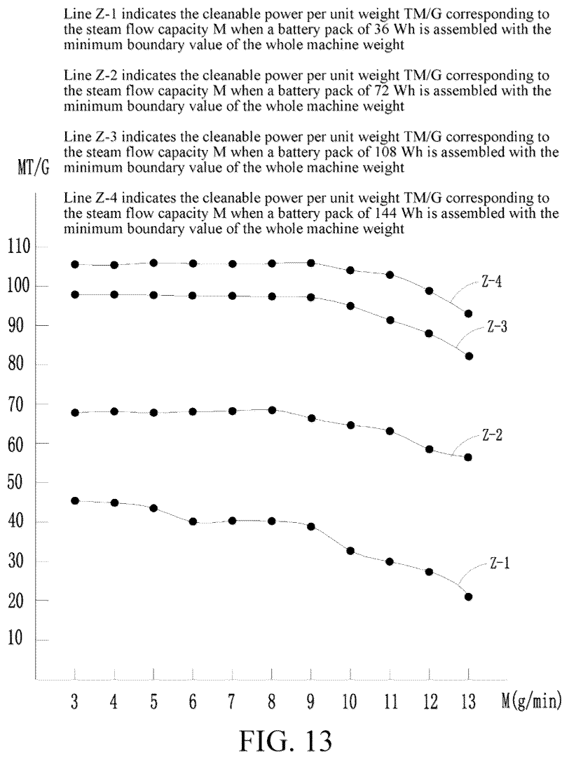

Referring to FIG. 13, when the capacities of the battery packs are 36 Wh, 72 Wh, 108 Wh and 144 Wh respectively, the cleanable power per unit weight MT/G of the hand-held steam cleaning apparatus is calculated using the maximum boundary value of the weight of the battery pack, and lines marked Z-1, Z-2, Z-3 and Z-4 are obtained to represent MT/G values when matching the battery packs of different capacities respectively.

As can be seen from FIG. 12 and FIG. 13, the value of the cleanable power per unit weight MT/G increases as the capacity of the battery pack increases.

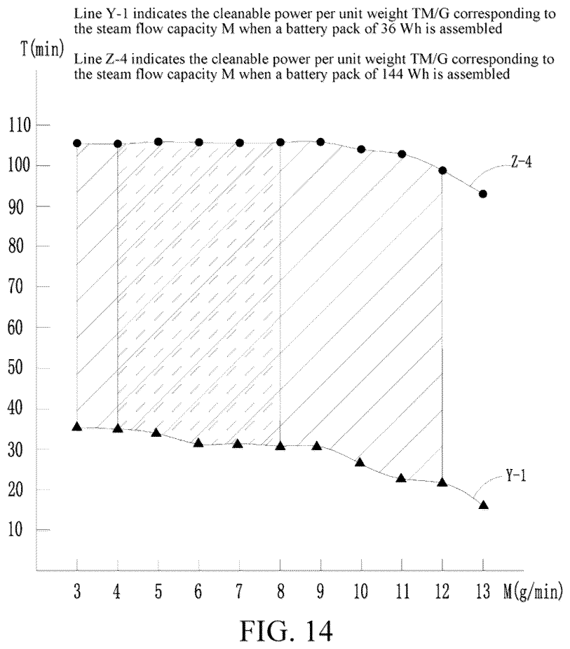

Referring further to FIG. 14, the corresponding line Y-1 when the battery pack of the minimum capacity of 36 Wh is in matched connection with a host of the hand-held steam cleaning apparatus and the corresponding line Z-4 when the battery pack of the maximum capacity of 144 Wh is in matched connection with the host of the hand-held steam cleaning apparatus respectively represent the two boundaries of the cleanable power per unit weight MT/G in the embodiment of this application, the steam flow capacity threshold range of 3 g/min to 12 g/min determined in the embodiment of this application can define the MT/G range in the embodiment of this application, i.e., a region represented by the shaded portion in the figure. In the embodiment of this application, 0.0216≤MT/G≤ 0.1060.

Further, according to the test, it can be seen that when the steam flow capacity is in the range of 4 g/min to 8 g/min, the apparatus can achieve a higher MT/G value and can meet the use requirements in more cleaning scenarios, which is more in line with the user's expectation for the DC hand-held steam cleaning apparatus in terms of power and performance, therefore, in the embodiment of this application, the example range of the steam flow capacity is 4 g/min to 8 g/min, correspondingly, the example range of the cleanable power per unit weight MT/G of the hand-held steam cleaning apparatus is 0.0309≤MT/G≤0.106.

It should be noted that, the weight of the battery pack mainly includes the weight of the battery cells, the weight of the housing and the weight of similar components such as a control circuit in the housing. The weights of the housing and the circuit component are essentially the same for the battery packs of different capacities Q. The larger the capacity Q of the battery pack, the larger the proportion of the weight of the battery cell. Therefore, although the capacity Q of the battery pack increases roughly proportionally to the weight of the battery pack, because the proportion of the weight of the components such as the housing becomes smaller in a battery pack of a large capacity, the ratio of the capacity Q to the weight of the battery pack actually increases as the capacity of the battery pack increases. In other words, the effect of a certain capacity increment on a weight increment in the battery pack of a large capacity will be less than the effect in a battery pack of a small capacity. Therefore, in theory, a higher MT/G value can be achieved when the battery pack of a large capacity is used. However, in order to minimize the negative impact of the whole machine weight on the user's operation, the key to obtain a successful DC hand-held steam cleaning apparatus is to achieve the apparatus parameters that meet the cleaning requirements with the capacity of the battery pack as small as possible, so that the steam cleaning apparatus has the desired cleaning power and is also small and lightweight.

In order to makes the values of the parameters of the steam flow capacity M and the continuous work time T as high as possible with a limited capacity of the battery pack, it is necessary to design the steam cleaning apparatus in such a way that the capacity Q of the battery pack is utilized as efficiently as possible. The total capacity of the battery pack can be divided into two parts: the efficiently utilized energy and the non-efficiently utilized energy. The efficiently utilized energy can be divided into energy consumed when the heating body heats the steam and energy consumed by other components of the steam cleaning apparatus. A detailed description is as below.

Firstly, the non-efficiently utilized energy.

As already mentioned, when the battery pack is discharged to the protection threshold, not all of the power is released, but a part of the power is retained and cannot be released to protect the battery pack from damage caused by over-discharge, therefore, the voltage at which the battery pack stops discharging is referred to as the over-discharge voltage threshold, or it can also be referred to as the cut-off voltage. The part of the power that cannot be released is related to the power of a power-using apparatus. When the power of the power-using apparatus is high, the required supply voltage thereof is large. The supply voltage of the battery pack is reduced as the power is released. The supply voltage of the battery pack is maximum when the battery pack is fully charged and is expressed as U0. With the release of the electric energy of the battery pack, the supply voltage of the battery pack gradually decreases, when it decreases to U′, the voltage cannot meet the power requirements of the power-using apparatus, the battery pack enters the battery protection state of cut-off discharge. The higher the power of the power-using apparatus, the earlier the battery pack reaches the over-discharge voltage threshold, the more power not released from the battery pack, and the lower the use efficiency for the power of the battery pack. As a result, for the same requirement for the power use amount, the demand for the power of the battery pack is higher, the power of the battery pack also affects the whole machine weight, thus making the value of the ratio of the cleanable power to the weight of the apparatus lower. To overcome the problem of the low utilization rate for the power of the battery pack under high power usage, the following solutions are taken in this embodiment.

(I) Reducing the work power of the heating body.

In the AC-powered steam cleaning apparatus, the heating power usually reaches 1000 W or even 2000 W. Such a high heating power certainly has advantages of rapid heating and sufficient power for the AC-powered steam cleaning apparatus, but it is not suitable for the DC-powered apparatus.

In order to enable the steam cleaning apparatus to match power supply of DC energy, and also to attenuate the adverse effects of high power consumption on the discharge rate of the battery pack, in this embodiment, the power of the steam cleaning apparatus is controlled at about 120 W to 600 W, for example, the power of the steam cleaning apparatus is controlled at about 180-400 W. As mentioned previously, the steam cleaning apparatus in this embodiment addresses the problem of contamination in light and medium work conditions first, so controlling the power of the apparatus within a relatively low range is compatible with the scenario in which the apparatus is used. Depending on the different steam flow capacities, the power of the heating body fluctuates within a certain range. Table 12 below shows the power of the heating body corresponding to the steam flow capacity of 3 g/min to 12 g/min, and the corresponding discharge efficiency of the battery pack (with the battery pack of 36 Wh as an example).

The discharge efficiency in Table 12 refers to the ratio of the power released to the total power when the battery pack is discharged to the cut-off voltage. From the data in the table, it can be seen that when the steam flow capacity is low, for example when the steam flow capacity is 3 g/min, the power of the apparatus is lowest, being only about 140 W, and at this moment, the discharge efficiency of the battery pack is highest, up to 90%. As the steam flow capacity increases, the power of the apparatus increases and the discharge efficiency of the battery pack gradually decreases, but can still reach more than 50%. The steam cleaning apparatus of this embodiment, by controlling the heating power, makes the discharge efficiency of the battery pack as high as possible, which is conducive to increasing the utilization rate for the capacity of the battery pack and reducing the requirement for the capacity of the battery pack while ensuring the cleaning performance, thus achieving an ideal value of the ratio of the cleanable power to the weight.

TABLE 12
Values of the power and the discharge efficiency of the
battery pack under different steam flow capacities.

| | Steam flow capacity g/min | | | | | | | | | |
|---|---|---|---|---|---|---|---|---|---|---|
| | 3 | 4 | 5 | 6 | 7 | 8 | 9 | 10 | 11 | 12 |
| Power W | 140.7 | 187.6 | 234.5 | 281.4 | 328.3 | 375.2 | 422.1 | 469 | 515.9 | 562.8 |
| Discharge efficiency of | 90% | 89% | 85% | 80% | 80% | 79% | 78% | 68% | 60% | 55% |
| the battery pack | | | | | | | | | | |

(II) Selecting a proper resistance value.

As mentioned previously, the cut-off voltage of the discharge of the battery pack affects the discharge amount of the battery pack, the higher the heating work voltage of the heating body, the faster the battery pack reaches the cut-off voltage. From P=U2/R, it can be seen that in the case of a certain heating power of the heating body, the work voltage of the heating body decreases with the decrease of the resistance value. Therefore, in the case that the power of the heating body can no longer decreases, a small resistance value can be designed to obtain a small work voltage, so that, as the required supply voltage of the apparatus is reduced, the battery pack can discharge more electric energy in the case of power supply of a battery pack of a certain capacity, and then the discharge efficiency of the battery pack is improved. However, the resistance value of the heating body cannot be reduced at will. On the one hand, it is necessary to consider the effect of designing a small resistance value on the form of the heating body, and on the other hand, more importantly, it is necessary to prevent a too small resistance value from causing a high current because the high current can easily damage the components in the circuit, especially the battery pack itself. Therefore, when the resistance value is reduced appropriately, the capacity of the circuit components to withstand different electrical parameters needs to be fully considered, so the resistance value cannot be designed arbitrarily. As the electrical parameters are usually interrelated, the model selection or design of parameters for a particular device often needs to be considered to match the model selection or design of parameters for other devices. For example, when the resistance value of the heating body is designed, it may be necessary to consider matching the resistance value with the parameter of the battery pack. If the battery pack is replaced freely after the matching design has been made, the battery pack may be damaged due to an excessive current or the like. In this embodiment, the battery pack of 36 Wh is used as an example for matching design. The resistance value of the heating body is designed to be in the range of 0.65-6.91 ohms when comprehensively considering the situation of reducing the resistance value of the heating body to reduce the work voltage and considering to control a circuit current to be maintained at a suitable value. When the voltage of the battery pack selected is 18 V, the resistance value is, for example, in the range of 0.65-1.28 ohms. In this way, by designing a reasonable resistance value, the circuit is guaranteed to work stably and the effect of increasing the discharge efficiency is also achieved, which can provide a strong support for simultaneously guaranteeing the clean performance and comfort of the apparatus.

(III) Segmented power supply of voltage.

In this embodiment, in order to make full use of the power of the battery pack, a segmented voltage is used to supply power to the heating body. Specifically, when the battery pack is fully charged, the work voltage of the heating body is set to U0, U0 is the full charge voltage of the battery pack, which is also the maximum voltage. After the battery pack works for a period of time, as the power of the battery pack gradually decreases, the work voltage of the heating body is set as U1, with U1<U0. At this moment, although the output voltage of the battery pack is reduced, it can still reach the standard for supplying power to the heating body. By reducing the work voltage of the heating body, the discharge time of the battery pack is prolonged until the output voltage of the battery pack is reduced to U2 and can no longer supply power to the heating body. By setting different voltage segments to supply power to the heating body, the time for the battery pack to supply power is prolonged, thereby enabling the battery pack to release more electrical energy, increasing the use rate for the capacity of the battery pack and improving the overall performance of the apparatus.

In one embodiment of this application, the full charge voltage of the battery pack is 20 V, and when the voltage of the battery pack is greater than or equal to 17 V, the heating body works at a first power, the first power being about 300 W. When the voltage of the battery pack is less than 17 V and greater than or equal to 14 V, the heating body works at a second power, the second power being about 200 W. If the voltage of the battery pack is less than 14 V, the control device controls the battery pack to stop discharging.

Secondly, the energy consumed by the heating body to heat water vapor.

The energy consumed by the heating body to heat the water vapor is the main consumption of the power of the battery pack. Ideally, if the heating body can convert all of the electrical energy consumed into heat energy absorbed for heating the water vapor, the use efficiency of the effective utilization capacity of the battery pack will be highest. As a rule, we want to increase the proportion of the heat absorbed by the heating body to heat the water vapor to the total energy consumed as much as possible. The more power of the battery pack will be used to heat the water into the water vapor, which means that the utilization rate of the power of the battery pack power is higher, the value of the product of the steam flow capacity M and the continuous work time T of the apparatus is higher at the given capacity, then, the value of MT generated within the unit capacity of the battery pack becomes larger, correspondingly, the value of the MT per unit weight G is greater, then the cleaning performance and comfort of the apparatus are ideal at the same time, and the overall performance of the steam cleaning apparatus will be high. In practice, the heating body will not only effectively use some of the power to heat the water vapor to convert the power into heat absorbed by the water, but will also lose some of the energy, i.e., the energy provided to the heating body to heat the water is not fully converted into heat absorbed by the water, and the lost energy cannot be effectively used. If the proportion of the energy lost is large, this means that the heating body is low in the utilization efficiency for the electric energy of the battery pack, which is not conducive for generating an ideal steam flow capacity or continuous work time when the capacity of the battery pack is certain, or the requirement for the capacity of the battery pack is higher when the steam flow capacity and the continuous work time are particular, and therefore an ideal ratio of the cleanable power to the weight cannot be achieved. The energy consumed by the heating body to heat the water into water vapor can be deduced through the following process.

TABLE 13
Look-up table for latent heat of water vaporization

| | | Latent | | | Latent | | | Latent | | | Latent |
|---|---|---|---|---|---|---|---|---|---|---|---|
| | | heat of | | | heat of | | | heat of | | | heat of |
| | Temper- | vapor- | | Temper- | vapor- | | Temper- | vapor- | | Temper- | vapor- |
| Pressure/ | ature/ | ization | Pressure/ | ature/ | ization | Pressure/ | ature/ | ization | Pressure/ | ature/ | ization |
| Mpa | ° C. | kJ/kg | MPa | ° C. | kJ/kg | MPa | ° C. | kJ/kg | MPa | ° C | kJ/kg |
| 0.001 | 6.9491 | 2484.1 | 0.09 | 96.7121 | 2265.3 | 1.3 | 191.644 | 1972.1 | 9 | 303.385 | 1378.9 |
| 0.002 | 17.5403 | 2459.1 | 0.1 | 99.634 | 2257.6 | 1.4 | 195.078 | 1959.1 | 10 | 311.037 | 1317.2 |
| 0.003 | 24.1142 | 2443.6 | 0.12 | 104.81 | 2243.9 | 1.5 | 198.327 | 1946.6 | 11 | 318.118 | 1255.7 |
| 0.004 | 28.9533 | 2432.2 | 0.14 | 109.318 | 2231.8 | 1.6 | 201.41 | 1934.6 | 12 | 324.715 | 1193.8 |
| 0.005 | 32.8793 | 2422.8 | 0.16 | 113.326 | 2220.9 | 1.7 | 204.346 | 1923 | 13 | 330.894 | 1131 |
| 0.006 | 36.1663 | 2415 | 0.18 | 116.941 | 2210.9 | 1.8 | 207.151 | 1911.7 | 14 | 396.707 | 1066.7 |
| 0.007 | 38.9967 | 2408.3 | 0.2 | 120.24 | 2201.7 | 1.9 | 209.838 | 1900.7 | 15 | 342.196 | 1000.2 |
| 0.008 | 41.5075 | 2402.3 | 0.25 | 127.444 | 2181.4 | 2 | 212.417 | 1890 | 16 | 347.396 | 930.8 |
| 0.000 | 43.7901 | 2396.8 | 0.3 | 133.566 | 2163.7 | 2.2 | 217.289 | 1869.4 | 17 | 352.334 | 857.1 |
| 0.01 | 45.7988 | 2392 | 0.35 | 138.891 | 2147.9 | 2.4 | 221.829 | 1849.8 | 18 | 357.034 | 777.4 |
| 0.015 | 53.9705 | 2372.3 | 0.4 | 143.642 | 2133.6 | 2.6 | 226.065 | 1330.8 | 19 | 361.514 | 688.9 |
| 0.02 | 60.065 | 2357.5 | 0.5 | 151.867 | 2108.2 | 2.8 | 230.096 | 1812.6 | 20 | 365.780 | 585.9 |
| 0.025 | 64.9726 | 2345.5 | 0.6 | 158.663 | 2086 | 3 | 233.893 | 1794.9 | 21 | 369.868 | 452.4 |
| 0.03 | 09.1041 | 2335.3 | 0.7 | 164.983 | 2066 | 3.5 | 242.507 | 1752.9 | | | |
| 0.04 | 75.872 | 2318.5 | 0.8 | 170.444 | 2047.7 | 4 | 250.394 | 1713.4 | | | |
| 0.05 | 81.3388 | 2304.8 | 0.9 | 175.389 | 2030.7 | 5 | 263.98 | 1639.5 | | | |
| 0.06 | 85.9496 | 2293.1 | 1 | 179.916 | 2014.8 | 6 | 275.625 | 1570.5 | | | |
| 0.07 | 89.9556 | 2282.8 | 1.1 | 184.1 | 1999.9 | 7 | 285.859 | 1504.8 | | | |
| 0.00 | 93.5107 | 2273.6 | 1.2 | 187.995 | 1965.7 | 8 | 295.048 | 1441.2 | | | |

First, the energy required to produce water vapor of a unit mass (1 g) is calculated as:

$$Qwater vapor = Qwater boiling + Qwater vaporization$$

At a standard atmospheric pressure, when the temperature of the water to be heated is T1=22° C.,

$$Qwater boiling = Cwater \times Mwater \times ( T 2 - T 1 ) = 4.2 \times 1000 J / kg ° C . \times 0.001 kg \times ( 100 ° C . - 22 ° C . ) = 327.6 J$$

where, Cwater is the specific heat capacity of water, which is 4.2×1000 J/kg° C. at the standard atmospheric pressure; Mwater is the mass of water, with the unit mass of 1 g herein.

The value of Qwater vaporization can be queried through the “table for latent heat of water vaporization”, in combination with the steam temperature (about 105° C.), the value of latent heat of vaporization is selected as 2243.9 KJ/kg for energy calculation, then

$$Qwater vapor = 327.6 + 2 243.9 = 2571.5 J$$

The energy consumption to generate the water vapor M (g/min) shall be 2571.5×M/60 W according to 60 J of electric heat generated per minute by 1 W of electric energy.

The power of the heating body at different steam flow capacities can be seen from the above-mentioned Table 13, and the power of the heating body represents actual energy consumption of the heating body. Table 14 below shows the values of the energy which shall be consumed and the power of the heating body at different steam flow capacities M. It can be seen that the actual power of the heating body is greater than the energy which shall be consumed, the ratio of the energy which shall be consumed to the power of the heating body reflects the capacity of the heating body to convert the electrical energy into the cleaning power of the steam cleaning apparatus, expressed as the thermal efficiency η2. It can be seen that the higher the thermal efficiency η2, the greater the capacity of the heating body to convert the electrical energy into the cleaning power, the more electrical energy that is efficiently utilized at the same capacity of the battery pack, and the more beneficial to achieve high cleaning performance.

TABLE 14
Comparison of the energy which shall be consumed and the power
of the heating body at different steam flow capacities.

| | Steam flow capacity g/min | | | | | | | | | |
|---|---|---|---|---|---|---|---|---|---|---|
| | 3 | 4 | 5 | 6 | 7 | 8 | 9 | 10 | 11 | 12 |
| Energy which shall be consumed/W | 128.6 | 171.4 | 214.3 | 257.2 | 300.0 | 342.9 | 385.7 | 428.6 | 471.4 | 514.3 |
| Power of the heating body/W | 140.7 | 187.6 | 234.5 | 281.4 | 328.3 | 375.2 | 422.1 | 469 | 515.9 | 562.8 |

The thermal efficiency of the heating body is related to the characteristics of the heating body itself. In this embodiment, the type of heating body is selected in order to obtain a higher thermal efficiency.

Heating technologies commonly used for conventional steam cleaning apparatus include an electric heating wire heating technology, a PTC ceramic heating technology, etc. Taking a steam mop as an example, the conventional steam cleaning apparatus mostly have a large volume and thus have a large tolerance for the volume of the heating body, and the conventional steam cleaning apparatus is powered by an AC power source, and has a large tolerance for the energy consumption loss, and the user does not need to consider the influence of a high load (which affects electrical parameters) on the battery pack. In a DC-powered steam cleaning apparatus, however, the selection of the heating body will affect the technology including the various aspects described above, such as the volume, the weight, and the thermal efficiency. Therefore, it is needed to select a heating technology for the DC hand-held steam cleaning apparatus that has a high thermal efficiency, a small volume, and a low weight.

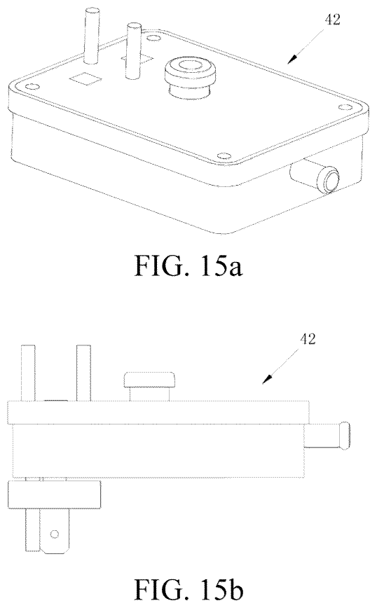

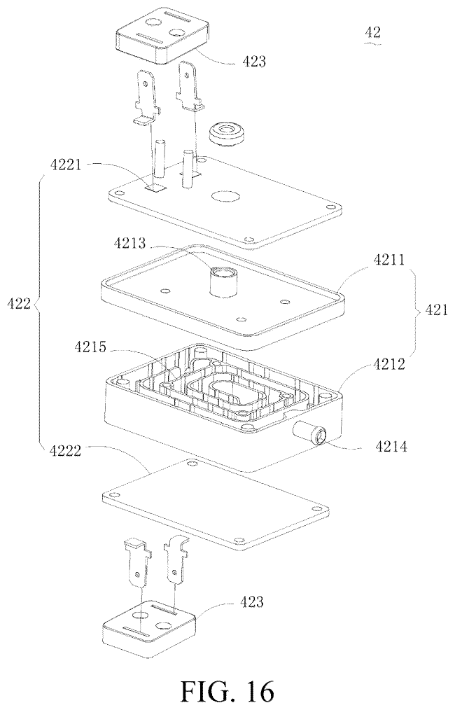

As shown in FIG. 15a, FIG. 15b and FIG. 16, in one embodiment of this application, the steam generating unit 4 uses a thick film heating technology and the output power of a thick film heater 42 is set to 350 W. The thick film heater 42 includes a steam generating portion 421, thick film heat generating bodies 422 disposed on the upper and lower surfaces of the steam generating portion 421, and an electrode holder 423 disposed on the thick film heat generating body. The steam generating portion 421 includes a first housing 4211 and a second housing 4212, which are closed to form the steam generating portion 421. The housing 420 is in contact with the thick film heat generating body 422, so that the thick film heat generating body 422 and the steam generating portion 421 are closely fitted to achieve fixed connection.

The steam generating unit 4 of the hand-held steam cleaning apparatus provided in this application is provided with double thermal insulation layers, where the first thermal insulation layer is closely adhered to the outer side of the thick film heat generating body 422, such as aerogel, aluminum silicate, aluminum oxide or silicon oxide wool, etc. The second thermal insulation layer is disposed as high temperature resistant plastic and wraps the outer side of the first thermal insulation layer, for example, PEEK, high temperature resistant modified PA66, etc. can be used. A housing 420 is on the outer side of the second thermal insulation layer, and a plastic housing can be used as the housing 420. It should be noted that, the housing 420 is divided into two parts wrapping and clamping the steam generating unit, and fastened in a snap-fit or screw manner, and at the same time, a shell wrapping the steam generating unit is also connected to the housing in a snap-fit or screw manner; a machine body shell 1 is on the outer side of the housing 420. The double thermal insulation layers can enable the steam generating unit 4 to achieve a good thermal insulation effect, so that the heat is stored in the steam generating unit 4, at the same time, the heat is not emitted outwards, and the heat loss is small, so that the thermal efficiency of the steam generating unit 4 is relatively high. At the same time, the shell 1 of the hand-held steam apparatus is not prone to generate heat, so as to avoid burning the user and improve user experience.

With further reference to FIG. 16 and FIG. 3 and FIG. 4, a flow channel communicating a liquid inlet 4213 with a steam outlet 4214 is disposed in a first housing 4211. A communicating pipeline is provided between the water pump 51 and the liquid inlet 4213 of the steam generating portion 421, and a communicating pipeline is provided between the steam outlet 4214 and the steam nozzle 6 correspondingly. A flow channel 4215 in the steam generating portion 421 is a labyrinth-type flow channel. Compared with the traditional heating method of AC electric heating wires, the thick film heat generating body required by this thick film heat generating technology has a small volume, a low heat loss, a large flow channel length of a corresponding steam unit, a high water flow heating speed and a high evaporation efficiency of water drops.

In order to prevent the situation that a film of the thick film heat generating body 422 is damaged after the temperature of the thick film heater 42 exceeds the preset temperature in use, an NTC temperature control element (not shown in the figure) is disposed on the side in contact with the thick film heat generating body 422. The temperature control element performs control adjustment when the actually measured temperature exceeds the preset temperature; The flow of the water pump is adjusted lower to prevent water dripping of the steam nozzle when the actually measured temperature is lower than a preset lowest temperature. It should be noted that, the thick film heat generating body uses a thick film resistor technology to form a thick film heat generating circuit on a substrate. A resistance wire used in the heat generating circuit is made from palladium silver or ruthenium paste, and the heat is conducted to heat the liquid in the steam generating portion 421.

In this embodiment, the thick film heater 42 is disposed in the main body 2 at one end of the handle 3, thus avoiding the situation that most of the heat of the heat generating body is transferred to a holding region of the handle, and consequently the handle becomes hot. The thick film heater 42 is also located between the steam nozzle 6 and the water pump 51, and the thick film heater 42, the steam nozzle 6 and the water pump 51 are linearly arranged on the main body 2, so that the internal structure setting of the main body 2 is compact.

In order to reduce the weight and volume of the machine, the water pump 51 in this application selects a small volume micro motor to power a pump head, such as a peristaltic pump or diaphragm pump.

In summary, the thermal efficiency of the steam generating unit 4 using the thick film resistance technology is relatively higher; Compared with conventional AC resistance wire heating bodies, because the thick film heater 42 has a high power of about 1000 W, the volume of the thick film heater 42 is reduced by 40% compared with that a conventional AC electric heating wire aluminum alloy assembly, which also means that a steam module of this design is light in weight and has a low heat loss. The thermal efficiency of the steam cleaning apparatus with the thick film heater 42 is increased to over 70%. The embodiment of this application uses a double layer thermal insulation technology and the labyrinth type flow channel design of the steam generating portion 421, so that the thermal efficiency of the thick film heater 42 will be increased to 78%. The steam cleaning apparatus of the embodiment of this application achieves a smaller weight with a higher thermal efficiency, thereby achieving a greater cleanable power per unit weight MT/G.

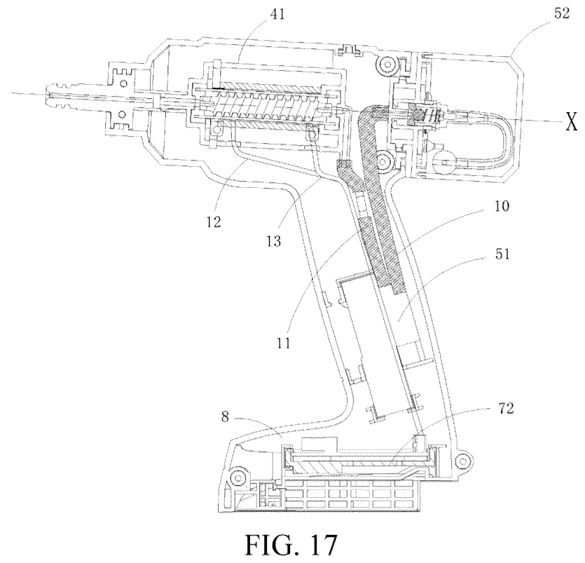

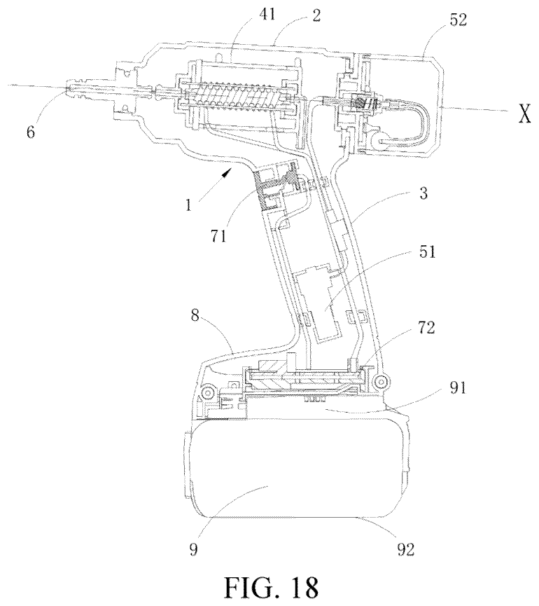

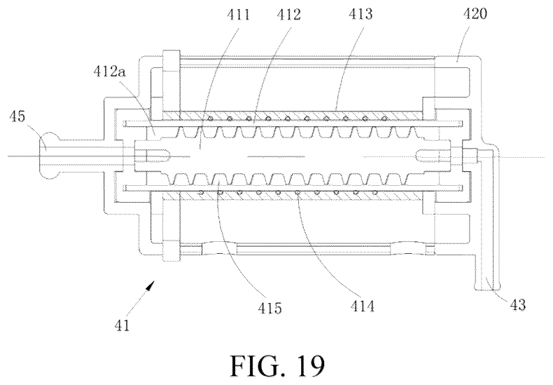

Referring to FIG. 17, FIG. 18 and FIG. 19, in one embodiment of this application, a quartz tube heating technology is used, and the steam generating unit 4 is disposed as a quartz tube heater 41. The quartz tube heater 41 is disposed in the main body 2, the water pump 51 is disposed in the handle 3, the water tank 52 and the water pump 51, and the water pump 51 and the quartz tube heater 41 are connected by a first water pipe 10 and a second water pipe 11 respectively, and a circuit board 72, the water pump 51 and the quartz tube heater 41 are connected electrically by wires 12 and 13. The steam nozzle 6, the quartz tube heater 41 and the water tank 52 are arranged sequentially along the longitudinal axis, X-axis, of the main body, making the structure arrangement compact.

The first water pipe 10 is disposed between the water tank 52 and the water pump 51, the second water pipe 11 is disposed between the water pump and the steam generating unit, and one of the first water pipe 10 and the second water pipe 11 is provided with a water flow detection unit (not shown in the figure). Before the water flow detection unit detects that there is water in the water pipe, the control device controls the water pump 51 to pump water at a first preset flow rate. When the water flow detection unit detects that there is water in the water pipe, the control device controls the steam generating unit to perform preheating so that the heating body reaches a preset working temperature, and controls the water pump 51 to pump water at a second preset flow rate, the second preset flow rate is smaller than the first preset flow rate. The time T1 required for water to flow through the water flow detection device to the entrance of the steam generating unit at the second preset flow rate, the time T0 for the steam generating unit to be preheated to the operating temperature, the steam generating unit is provided with a time threshold TMAX which refers to the time from preheating to preventing the heat generating body 414 from fusing, the time T1 satisfies T0≤T1<TMAX. In this embodiment, the preheating time T0 is less than 2 seconds, the anti-fuse time threshold TMAX is less than 5 seconds, and T1 satisfies 2 seconds ≤T1<5 seconds. The steam generating unit can raise the operating temperature to between 800° C. and 1200°° C. during the preheating time T0. The preheating time T0 is not less than 2 seconds. The time T2 for water to enter the steam generating unit from the inlet of the steam generating unit to be heated and vaporized and flow out from the outlet of the steam generating unit is not less than 3 seconds. The time T′ from the start of the water pump 51 to the steam output from the steam nozzle satisfies 5 seconds ≤T′<20 seconds.

Referring further to FIG. 19, the quartz tube heater 41, which includes a housing 420, a transparent tube 412 mounted inside the housing 420, a screw 411 housed in an inner cavity 412a of the transparent tube, a heat generating body 414 spirally wound and fitted to the outer surface of the transparent tube 412, and a heat preserving layer 413 covering the outer surface of the heat generating body 414. The housing 420 may be made of aluminum or other metal materials.

A spiral channel 415 for water to pass is formed between the screw 411 and the inner cavity wall of the transparent tube 412. The minimum clearance between the inner cavity wall of the pipeline of the transparent tube 412 and the screw 411 is controlled to be less than 0.2 mm. With this setting, the water pumped in by the water pump 51 moves forwards from the inlet end 43 of the quartz tube heater 41 along the spiral channel 415 and flows out from the outlet end 45 of the transparent tube 412. The screw 411 placed in the transparent tube 412 not only plays the role of a water flow guide rod, but also increases the heating path of water and decreases the flow speed of water.

The transparent tube 412 is made of glass capable of withstanding high temperatures above 800 degrees Celsius. For example, the transparent tube 412 is made of a quartz material which has the advantages of a good radiation absorption property, good stability and high electrical heat conversion efficiency, and can operate at high temperatures of 800-1200° C. The water is heated by quartz tubes and the thermal efficiency can usually reach more than 85%. Of course, a transparent tube 22 can also be made of other materials that are capable of receiving thermal radiation light and are resistant to high temperatures.

The heat generating body 414 uses resistance wires or resistance discs, the heat generating body 414 is made of a nickel-based alloy capable of withstanding high temperatures above 800 degrees Celsius, for example, nickel-chromium, nickel-chromium aluminum, etc., and the electrical resistivity of the nickel-based alloy material varies little at high temperatures, which has little effect on the power of a steam generator 2.

The heat preserving layer 413 is disposed on the outer side of the heat generating body 414, and is used to preserve heat of the transparent tube 412 and the heat generating body 414. In one embodiment, the heat preserving layer includes a first heat preserving layer wrapping the outer surface of the heat generating body 414, a second heat preserving layer disposed on the inner surface of the housing 420, and an air thermal insulation layer between the first heat preserving layer and the second heat preserving layer. Since the heating temperature of the heat generating body 414 is high, the first heat preserving layer and the second heat preserving layer may be made from thermal insulation materials resistant to high temperature, such as, aluminum silicate, aluminum oxide or silicon oxide wool, etc. The thickness of the first heat preserving layer and the second heat preserving layer may be set at 3 mm-9 mm, and the spacing between the first heat preserving layer and the second heat preserving layer (i.e., the thickness of the air thermal insulation layer) may be 3-15 mm.

In another alternative embodiment, due to the high heating temperature of the heat generating body 414, it is also possible to first dispose a ceramic tube or clay tube on the outer surface of the heat generating body 414 in a sleeving mode, and then the first heat preserving layer is disposed on the outer surface of the ceramic tube or clay tube.

In summary, the quartz tube heater 41 provided by this application transfers heat to the water inside the transparent tube 412 such as a quartz tube in both modes of heat radiation and heat conduction in the case where the heat of the heat generating body 414 is preserved better, compared with a current steam generator which generally transfers heat only in one mode of heat conduction, the steam generator provided by this application transfers heat faster and more fully, and is also more able to save electric energy, and the thermal efficiency of the quartz tube heater 41 can be more than 90%. Compared with a conventional AC resistance wire heating body, the volume of the quartz tube heater 41 is also reduced about 40% compared with that of the conventional AC electric heating wire aluminum alloy assembly, and the quartz tube heater 41 of this design is lighter in weight. The steam cleaning apparatus of this embodiment is enabled to achieve a smaller weight, thereby achieving a greater cleaning power per unit weight MT/G.

Certainly, in other embodiments, other types of heating bodies can also be selected for heating, as long as the heating body can achieve a high thermal efficiency, such as PTC ceramic tube heaters.

Thirdly, the electric energy consumed by other components.

The electrical energy consumed by other components mainly includes the electrical energy consumed by the pump and the electrical energy consumed by circuit components. The set-up of the pump, the water pipe and the circuit board have already been mentioned before when the layout of the hand-held steam cleaning apparatus is introduced and will not be repeated here. The proportion of energy consumption of other parts such as the pump and circuit components is less than 5% compared with the proportion of the energy consumption of the heating body and is almost negligible, therefore it is not a key design to improve the utilization rate for the capacity of the battery pack.

In summary, the steam cleaning apparatus of this embodiment, by increasing the utilization rate for the capacity of the battery pack as much as possible, fully converts the power of the battery pack into the cleaning power of the steam cleaning apparatus with a limited supply of the power of the battery pack, thus achieving, within a unit weight G, higher values of parameters of the steam flow capacity M and the continuous work time T, i.e., a more desirable value of the cleanable power MT, and thus achieving double effects of both the cleaning power and the user comfort of the DC hand-held steam cleaning apparatus.

Of course, the energy density of the battery pack is also an important parameter to achieve a large value of MT/G. The greater the power per unit weight of the battery pack, the more beneficial it is for the apparatus to meet the requirements for both the cleaning performance and the operational comfort at the same time. In this embodiment, lithium-ion batteries are used for supplying power. Due to the high energy density of the lithium-ion batteries compared to conventional storage battery technologies such as lead-acid batteries, the lithium-ion batteries have become the main energy option for cordless power tools. The technology related to the lithium-ion batteries has been mentioned earlier and will not be repeated here.

The DC hand-held steam cleaning apparatus of this embodiment can meet the basic cleaning power requirement while keeping energy consumption within a reasonable range by selecting reasonable work parameters and making effective use of limited DC energy, thus making the weight of the whole machine controllable. The parameter of the ratio MT/G of the cleanable power to the weight reflects the cleaning power per unit weight of the apparatus and ensures that the cleaning power per unit weight of the apparatus is ideal, thus reflecting both the high cleaning power and the comfortable use of the apparatus, which achieves a breakthrough in the design of the DC steam cleaning apparatus.

MT/G reflects the balance between the cleaning power and the comfort of the steam cleaning apparatus. In this embodiment, the value of MT/G is in a regular range that fluctuates depending on changes in the capacity of the battery pack matched with the apparatus, or the work parameter of the apparatus, but the design core thereof for showing the ratio of the cleaning power to the weight of the apparatus remains unchanged, thus, in this embodiment, acquiring the value of MT/G meeting the requirement is key design to obtain a successful DC hand-held steam cleaning apparatus. In this embodiment, the ratio MT/G of the cleanable power to the weight of the steam cleaning apparatus is in the range of 0.0216≤MT/G≤0.1060, and when this ratio is in the range of 0.0216≤MT/G≤0.1060, we consider that both the work performance requirement and the operational comfort requirement of the product can be met at the same time. For example, when the example range of the steam flow capacity is 4 g/min to 8 g/min, MT/G is in the range of 0.0309≤MT/G≤0.1060.

For example, in this embodiment, G is in the range of less than 2.0 kg. Further, G is, for example, in the range of 0.9 kg to 1.4 kg, and the maneuverability of the apparatus is particularly facilitated when G is in the range of a lighter weight.

For example, in this embodiment, M is in the range of 3 g to 12 g. Further, M is, for example, in the range of 4 g to 8 g, when M is in the range of 4 g to 8 g, the cleaning effect is more desirable for the light and medium work conditions.

For example, in this embodiment, the capacity of the battery pack is 36 wh to 144 wh. Further, the capacity of the battery pack is, for example, 36 wh to 108 wh. It will be appreciated that the larger the capacity Q of the battery pack, the greater the power supply capacity and the more beneficial the cleaning power of the steam cleaning apparatus. However, a larger capacity will result in a larger whole machine weight, and it is known from the test that when the capacity of the battery pack is 36 wh to 108 wh, the cleaning power of the apparatus can be achieved well, therefore, considering the influence of the weight of the apparatus on the overall performance of the product, it is more appropriate to select the capacity of the battery pack of 36 wh to 108 wh.

It should be noted here that the multiple embodiments in this application can be combined, and any combination that may exist is within the scope disclosed in this application. The description above is only example embodiments of this application and not intended to limit this application. Any modification, equivalent replacement, etc. made within the spirit and principle of this application shall fall within the protection scope of this application.

What is claimed is:

1. A hand-held steam cleaning apparatus comprising:
a housing provided with a handle for holding;
a steam generating unit comprising a heating body and configured to heat and vaporize water into steam, configured to produce a steam flow capacity M when performing cleaning work;
a steam nozzle configured to output the steam;
a water supply device comprising a water tank and a water pump configured to pump water in the water tank into the steam generating unit, and
a control device, configured to control an operation of the water pump and the heating body,
wherein:
the hand-held steam cleaning apparatus is powered by a battery pack;
a weight of the hand-held steam cleaning apparatus is not greater than 2 kg when the housing is fitted with the battery pack and the water tank is fully loaded;
a capacity of the battery pack is in a range of 36-144 Wh;
M is in a range of 3-12 g/min; and
the hand-held steam cleaning apparatus has a continuous work time, T, defined from a start of steam production to an end of steam production, the continuous work time being not less than 2 min.

2. The hand-held steam cleaning apparatus according to claim 1, wherein:
a cleaning power MT of the hand-held steam cleaning apparatus is defined as a product of the steam flow capacity M and the continuous work time T; and
the cleaning power MT is between 25.2 g˜166 g.

3. The hand-held steam cleaning apparatus according to claim 2, wherein:
a weight when the housing is fitted with the battery pack and the water tank is fully loaded is a whole machine weight G,
a ratio MT/G of the product MT of the steam flow capacity M and the continuous work time T to the whole machine weight G of the hand-held steam cleaning apparatus is the cleaning power per unit weight, and
a value of the cleaning power per unit weight MT/G satisfies 0.0216≤MT/G≤0.1060.

4. The hand-held steam cleaning apparatus according to claim 1, wherein a power of the steam generating unit is in a range of 120-600 W.

5. The hand-held steam cleaning apparatus according to claim 1, wherein a thermal efficiency of the steam generating unit is greater than 70%.

6. The hand-held steam cleaning apparatus according to claim 1, wherein:
the housing comprises a main body;
an obtuse angle is set between an axis of the main body and an axis of the handle;
an end of the handle away from the main body is provided with a mounting base;
the battery pack is detachably connected to the mounting base; and
a bottom of the battery pack is provided with a support surface that supports the hand-held steam cleaning apparatus upright on a reference plane.

7. The hand-held steam cleaning apparatus according to claim 6, wherein:
the steam generating unit is accommodated in the main body; and
the steam nozzle, the steam generating unit, and the water tank are arranged in a sequence along the axis of the main body.

8. The hand-held steam cleaning apparatus according to claim 6, wherein:
an auxiliary brush head is detachably coupled to the steam nozzle; and
a brush surface of the auxiliary brush head is approximately parallel to the axis of the handle.

9. The hand-held steam cleaning apparatus according to claim 1, wherein:
the control device comprises a control trigger set on the handle and a circuit board;
the control trigger is electrically connected to the circuit board and the battery pack; and
the control trigger is configured to start an operation of the water pump and the heating body to produce instant steam.

10. A hand-held steam cleaning apparatus comprising:
a housing provided with a handle for holding;
a steam generating unit, disposed in the housing, comprising a heating body, and configured to heat and vaporize water into steam, configured to produce a steam flow capacity M, when performing cleaning work;
a steam nozzle communicating with the steam generating unit and configured to output the steam; and
a water supply device configured to deliver liquid to the steam generating unit; the water supply device comprising a water tank and a water pump configured to pump water in the water tank into the steam generating unit,
wherein:
the hand-held steam cleaning apparatus is powered by a battery pack;
the hand-held steam cleaning apparatus has a continuous work time T, defined from a start of steam production to an end of steam production;
a cleaning power MT of the hand-held steam cleaning apparatus is defined as a product of the steam flow capacity M and the continuous work time T, a weight when the housing is fitted with the battery pack and the water tank is fully loaded is a whole machine weight G, and a ratio MT/G of the cleaning power MT to the whole machine weight G of the hand-held steam cleaning apparatus is a cleaning power per unit weight; and
a value of the cleaning power per unit weight MT/G satisfies 0.0216≤MT/G≤0.1060.

11. The hand-held steam cleaning apparatus according to claim 1, wherein the value of the cleaning power per unit weight MT/G satisfies 0.0309≤MT/G≤0.1060.

12. The hand-held steam cleaning apparatus according to claim 10, wherein the steam flow capacity M is greater than or equal to 3 g/min, and less than or equal to 12 g/min.

13. The hand-held steam cleaning apparatus according to claim 12 wherein the steam flow capacity M is greater than or equal to 4 g/min, and less than or equal to 8 g/min.

14. The hand-held steam cleaning apparatus according to claim 10, wherein a capacity of the battery pack is greater than or equal to 36 Wh, and less than or equal to 144 Wh.

15. The hand-held steam cleaning apparatus according to claim 10, wherein a whole machine weight is not greater than 2 kg.

16. The hand-held steam cleaning apparatus according to claim 10, wherein a power consumption of the steam generating unit is in a range of 120-600 W, or in a range of 180-400 W.

17. The hand-held steam cleaning apparatus according to claim 10, wherein a resistance range of the heating body is 0.65-6.91 ohms.

18. The hand-held steam cleaning apparatus according to claim 10, wherein a thermal efficiency of the steam generating unit is greater than 70%, or between 85% and 95%.

19. A hand-held steam cleaning apparatus comprising:
a housing provided with a handle for holding;
a steam generating unit disposed in the housing, comprising a heating body and configured to heat water and vaporize the water into steam;
a steam nozzle communicating with the steam generating unit and configured to output the steam;
a water supply device, configured to deliver liquid to the steam generating unit; the water supply device comprising a water tank and a water pump configured to pump the water in the water tank into the steam generating unit; and
a control device configured to control a water pump and heating body to produce instant steam;
wherein:
the hand-held steam cleaning apparatus is powered by a battery pack;
a weight of the hand-held steam cleaning apparatus is not greater than 2 kg when the housing is fitted with the battery pack and the water tank is fully loaded;
the steam generating unit is configured to produce a steam flow capacity M, when performing cleaning work;
the hand-held steam cleaning apparatus has a continuous work time, T, defined from a start of steam production to an end of steam production; and
a cleaning power MT of the hand-held steam cleaning apparatus is defined as a product of the steam flow capacity M and the continuous work time T, MT being between 25.2 g˜166 g.

20. The hand-held steam cleaning apparatus according to claim 19, wherein:
a weight when the housing is fitted with the battery pack and the water tank is fully loaded is a whole machine weight G;
a ratio MT/G of the product MT of the steam flow capacity and the continuous work time to the whole machine weight G of the hand-held steam cleaning apparatus is the cleaning power per unit weight; and
a value of the MT/G satisfies 0.0216≤MT/G≤0.1060.
